(19) United States
(12) Patent Application Publication
(10) Pub. No.: US 2020/0317532 A1
(43) Pub. Date: Oct. 8, 2020

(54) HIGHLY EFFICIENT SOLIDOTHERMAL SYNTHESIS OF ZEOLITIC MATERIALS

(71) Applicant: BASF SE, Ludwigshafen am Rhein (DE)

(72) Inventors: Andrei-Nicolae PARVULESCU, Ludwigshafen (DE); Stefan MAURER, Shanghai (CN); Yu DAI, Shanghai (CN); UIrich MUELLER, Ludwigshafen (DE); Fengshou XIAO, Hangzhou, Zheijiang (CN); Chaoqun BIAN, Hangzhou, Zheijang (CN); Robert MCGUIRE, Florham, NJ (US)

(73) Assignee: BASF SE, Ludwigshafen am Rhein (DE)

(21) Appl. No.: 16/336,661

(22) PCT Filed: Sep. 22, 2017
(86) PCT No.: PCT/CN2017/102887

§ 371 Date: Mar. 26, 2019

(51) Int. Cl. C01B 39/48

(52) U.S. Cl. CPC C01B 39/48

(57) ABSTRACT

A process for preparing a zeolitic material having a zeolitic framework structure which exhibits a molar ratio (aAl₂O₃):SiO₂ or a crystalline precursor thereof, comprising (i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ and optionally one or more compounds comprising Al from which Al₂O₃ in the zeolitic framework structure is formed; (ii) subjecting the mixture obtained in (i) to crystallization at a crystallization temperature in the range of from 110 to 350° C., preferably in the range of from 190 to 350° C., and for a crystallization time in the range of from 0.1 to 48 h.

The present invention is directed to a highly efficient process for preparing zeolitic materials, in particular to a solidothermal synthesis of zeolitic materials wherein highly favorable space-time yields are achieved. Further, the present invention relates to the zeolitic materials which are obtainable or obtained by this process.

Zeolites, such as zeolitic materials having framework type MFI, MOR, or BEA, as useful adsorbents, ion exchangers, and catalysts, are widely applied in industrial processes, and their syntheses are usually performed under hydrothermal conditions, wherein the space-time yield is one of most important factors for industrial-scale processes for preparing the zeolites. Another example of a zeolitic material having excellent catalytic properties is a material having the RUB-36 structure. Thus, much attention is paid to improve the space-time yields by reducing the amount of water solvent and increasing crystallization rate. In addition, it is well known that the crystallization rate of zeolites should be accelerated at higher temperatures according to the Arrhenius formula, which reasonably enhance the space-time yields of zeolites. However, it is very difficult to perform the hydrothermal synthesis of zeolites at higher temperatures since the organic template compounds for the synthesis of zeolites under the high-temperature hydrothermal conditions are unstable due to the decomposition of organic species in strong alkaline media. WO 2016/058541 A1 discloses processes for preparing zeolitic materials wherein the maximum temperature according to all examples is 180° C.

It was an object of the present invention to provide a highly efficient process for preparing zeolitic materials allowing for achieving high space-time yields. It was a further object of the invention to provide said highly efficient process which should be applicable for a wide variety of zeolites. It was a further object of the invention to provide said highly efficient process which should be applicable for zeolites which are prepared in the presence of an organotemplate compound as well as for zeolites which are prepared in the absence of an organotemplate compound. It was yet a further object of the invention to provide a zeolite catalyst with improved catalytic properties in the methanol-to-olefins reaction than the conventional hydrothermal synthesized ones.

Therefore, the present invention relates to a process for preparing a zeolitic material having a zeolitic framework structure which exhibits a molar ratio (a Al₂O₃):SiO₂ or a crystalline precursor thereof, wherein a is a number in the range of from 0 to 0.5, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
(ii) subjecting the mixture obtained in (i) to crystallization at a crystallization temperature in the range of from 110 to 350° C., preferably in the range of from 190 to 350° C., and for a crystallization time in the range of from 0.1 to 48 h, obtaining the zeolitic material having a zeolitic framework structure which exhibits a molar ratio (a Al₂O₃):SiO₂ or the crystalline precursor thereof.

The term “crystalline precursor of a zeolitic material having a zeolitic framework structure which exhibits a molar ratio (a Al₂O₃):SiO₂” as used according to the present invention relates to a two-dimensional layered crystalline material from which, when subjected to calcination, a three-dimensional zeolitic material is obtained. Generally, examples of such crystalline precursors are crystalline materials having RUB-36 structure or the layered precursor of a zeolitic material having MWW zeolitic framework type.

With regard to the molar ratio (a Al₂O₃):SiO₂, no specific restrictions exist. Preferably, a is in the range of from 0 to 0.45, more preferably in the range of from 0 to 0.4, more preferably in the range of from 0 to 0.35, more preferably in the range of from 0 to 0.3, more preferably in the range of from 0 to 0.25, more preferably in the range of from 0 to 0.2. For zeolitic materials which do not contain Al in the zeolitic framework structure, a is 0. For zeolitic material which contain Al in the zeolitic framework structure, a is preferably in the range of from 0.001 to 0.5, more preferably in the range of from 0.0015 to 0.45, more preferably in the range of from 0.002 to 0.4, more preferably in the range of from 0.0025 to 0.35, more preferably in the range of from 0.003 to 0.3, more preferably in the range of from 0.0035 to 0.25, more preferably in the range of from 0.004 to 0.2.

Generally, it is conceivable that zeolitic materials are prepared which contain, in addition to Si and optionally Al, one or more further heteroatoms in the zeolitic framework structure, for example one or more further heteroatoms X which, in the zeolitic framework structure, are present as XO₂ and/or one or more further heteroatoms Y which, in the zeolitic framework structure, are present as Y₂O₃. Example of such heteroatoms include, but are not restricted to, Ti, Zr, V, Nb, Ta, Cr, Mo, W, Mn, Fe, Cu, Co, Ni, Zn, Ga, Ge, In, Pb. Preferably, the framework structure of the zeolitic materials contains no heteroatoms in addition to Si and optionally Al. Therefore, it is preferred that the the framework structure of the zeolitic materials is formed either by Si and Al and O, or by Si and O.

With regard to the zeolitic framework types, no specific restrictions exist. Generally, it is conceivable that the zeolitic framework type is one of ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, —CHI, -CLO, CON, CSV, CZP, DAC, DDR, DFO, DFT, DOH, DON, EAB, EDI, EEl, EMT, EON, EPI, ERI, ESV, ETR, EUO, *-EWT, EZT, FAR, FAU, FER, FRA, GIS, GIU, GME, GON, GOO, HEU, IFO, IFR, -IFU, IFW, IFY, IHW, IMF, IRN, IRR, —IRY, ISV, ITE, ITG, ITH, *-ITN, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, *MRE, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POS, PSI, PUN, RHO, -RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, *SFV, SFW, SGT, SIV, SOD, SOF, SOS, SSF, *-SSO, SSY, STF, STI, *STO, STT, STW, —SVR, SVV, SZR, TER, THO, TOL, TON, TSC, TUN, UEI, UFI, UOS, UOV, UOZ, USI, UTL, UWY, VET, VFI, VNI, VSV, WEI, -WEN, YUG, ZON, or a mixed type of two or more thereof. Preferably, the zeolitic material has framework type BEA, CHA, MFI, MEL, MOR, CDO, AEI, FER, SAV, or a mixed type of two or more thereof. More preferably, the zeolitic material has framework type BEA, CHA, MFI, MOR, CDO, or a mixed type of two or more thereof. More preferably, the zeolitic material has framework type BEA, CHA, MFI, MOR, CDO, more preferably framework type MFI, or a mixed type of two or more thereof. Preferably, the zeolitic framework structure of the zeolitic material does not exhibit framework type MWW. With regard to the crystalline precursor of the zeolitic material, it is preferred that is has the RUB-36 structure.

With regard to the water content of the silica gel, it is preferred that c is in the range of from 0.005 to 2.45, more preferably in the range of from 0.01 to 2.4, more preferably in the range of from 0.02 to 2.3, more preferably in the range of from 0.03 to 2.2, more preferably in the range of from 0.04 to 2.1, more preferably in the range of from 0.05 to 2.0.

With regard to the water content of the silica gel, it is alternatively preferred that c is in the range of from 0.1 to 2.4, preferably in the range of from 0.2 to 2.4, more preferably in the range of from 0.3 to 2.4, more preferably in the range of from 0.4 to 2.2, more preferably in the range of from 0.5 to 2.0, more preferably in the range of from 0.6 to 1.8, more preferably in the range of from 0.7 to 1.6, more preferably in the range of from 0.8 to 1.4, more preferably in the range of from 0.9 to 1.2.

With regard to the water content of the mixture prepared in (i), it is preferred that b is in the range of from 0.005 to 2, more preferably in the range of from 0.01 to 2, more preferably in the range of from 0.05 to 2, more preferably in the range of from 0.1 to 2, more preferably in the range of from 0.2 to 2, more preferably in the range of from 0.3 to 2, more preferably in the range of from 0.4 to 2, more preferably in the range of from 0.5 to 2.

With regard to the water content of the mixture prepared in (i), it is alternatively preferred that b is in the range of from 0.1 to 2, more preferably in the range of from 0.2 to 2, more preferably in the range of from 0.3 to 2, more preferably in the range of from 0.4 to 2, more preferably in the range of from 0.5 to 2, more preferably in the range of from 0.6 to 1.8, more preferably in the range of from 0.7 to 1.6, more preferably in the range of from 0.8 to 1.4, more preferably in the range of from 0.9 to 1.2.

Preferably, the present invention preferably relates to a process for preparing a zeolitic material having a zeolitic framework structure which exhibits a molar ratio (a Al₂O₃):SiO₂ and which has zeolitic framework type BEA, wherein a is a number in the range of from 0 to 0.5, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
(ii) subjecting the mixture obtained in (i) to crystallization at a crystallization temperature in the range of from 190 to 350° C. and for a crystallization time in the range of from 0.1 to 48 h, obtaining the zeolitic material having a zeolitic framework structure which exhibits a molar ratio (a Al₂O₃):SiO₂.

Preferably, the present invention preferably relates to a process for preparing a zeolitic material having a zeolitic framework structure which exhibits a molar ratio (a Al₂O₃):SiO₂ and which has zeolitic framework type MOR, wherein a is a number in the range of from 0 to 0.5, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
(ii) subjecting the mixture obtained in (i) to crystallization at a crystallization temperature in the range of from 190 to 350° C. and for a crystallization time in the range of from 0.1 to 48 h, obtaining the zeolitic material having a zeolitic framework structure which exhibits a molar ratio (a Al₂O₃):SiO₂.

Preferably, the present invention preferably relates to a process for preparing a zeolitic material having a zeolitic framework structure which exhibits a molar ratio (a Al₂O₃):SiO₂ and which has zeolitic framework type MFI, wherein a is 0, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
(ii) subjecting the mixture obtained in (i) to crystallization at a crystallization temperature in the range of from 190 to 350° C. and for a crystallization time in the range of from 0.1 to 48 h, obtaining the zeolitic material having a zeolitic framework structure which exhibits a molar ratio (a Al₂O₃):SiO₂.

Alternatively, it is preferred that the present invention preferably relates to a process for preparing a zeolitic material having a zeolitic framework structure which exhibits a molar ratio (a Al₂O₃):SiO₂ and which has zeolitic framework type MFI, wherein a is in the range of from 0.001 to 0.3, preferably 0.0012 to 0.1, more preferably 0.0013 to 0.05, more preferably 0.0014 to 0.01, more preferably 0.0015 to 0.005, said process comprising
(i) preparing a mixture comprising H₂O, one or more compounds comprising Si from which SiO₂ in the zeolitic framework structure is formed, said one or more compounds comprising a silica gel, preferably fumed silica, exhibiting a molar ratio (c H₂O):SiO₂ wherein c is a number in the range of from 0 to 2.5, preferably in the range of 0.9 to 1.2, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0, preferably wherein b is a number in the range of from 0.9 to 1.2;
(ii) subjecting the mixture obtained in (i) to crystallization at a crystallization temperature in the range of from 140 to 325° C., preferably at a crystallization temperature in the range of from 180 to 300° C., more preferably at a crystallization temperature in the range of from 240 to 250° C., and for a crystallization time in the range of from 0.1 to 48 h, preferably for a crystallization time in the range of from 20 to 350 minutes, more preferably in the range of from 85 to 95 minutes, obtaining the zeolitic material having a zeolitic framework structure MFI which exhibits a molar ratio (a Al₂O₃):SiO₂.

Preferably, the present invention preferably relates to a process for preparing a zeolitic material having a zeolitic framework structure which exhibits a molar ratio (a Al₂O₃):SiO₂ and which has zeolitic framework type CHA, wherein a is a number in the range of from 0 to 0.5, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
(ii) subjecting the mixture obtained in (i) to crystallization at a crystallization temperature in the range of from 190 to 350° C. and for a crystallization time in the range of from 0.1 to 48 h, obtaining the zeolitic material having a zeolitic framework structure which exhibits a molar ratio (a Al₂O₃):SiO₂.

Preferably, the present invention preferably relates to a process for preparing a crystalline precursor of zeolitic material having a zeolitic framework structure which exhibits a molar ratio (a Al₂O₃):SiO₂, wherein the precursor has RUB-36 structure, wherein a is a number in the range of from 0 to 0.5, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
(ii) subjecting the mixture obtained in (i) to crystallization at a crystallization temperature in the range of from 190 to 350° C. and for a crystallization time in the range of from 0.1 to 48 h, obtaining the crystalline precursor.

According to the present invention, it is possible to prepare the mixture according to (i) which contains only one source for SiO₂. In this case, the mixture prepared in (i) comprises one compound comprising Si from which SiO₂ in the zeolitic framework structure is formed, wherein this compound is the silica gel exhibiting a molar ratio (c H₂O):SiO₂. It is also possible to prepare the mixture prepared according to (i) which contains two or more sources for SiO₂. In this case, the mixture prepared in (i) comprises two or more compounds comprising Si from which SiO₂ in the zeolitic framework structure is formed, preferably comprises two compounds comprising Si from which SiO₂ in the zeolitic framework structure is formed, wherein one of the two or more compounds is the silica gel exhibiting a molar ratio (c H₂O):SiO₂ and the one or more other compounds is/are a further suitable source for SiO₂. It is preferred that two or more compounds comprising Si from which SiO₂ in the zeolitic framework structure is formed comprise, a sodium silicate, a white carbon black, an amorphous silica powder, or a fumed silica, preferably a sodium silicate, and/or a fumed silica, more preferably a Na₂SiO₃ and/or fumed silica, more preferably Na₂SiO₃×9 H₂O as a further source for SiO₂. If seed crystals are employed in the process which comprise Si, it is possible that these seed crystals are a further source for SiO₂ in the mixture prepared in (i).

If a is not 0, the respective source for Al in the mixture prepared in (i) is not subjected to any specific restrictions. Preferably, the one or more compounds comprising Al from which Al₂O₃ in the zeolitic framework structure is formed comprise one or more of an aluminum sulfate, preferably Al₂(SO₄)₃, a sodium aluminate, preferably NaAlO₂, and a boehmite. If seed crystals are employed in the process which comprise Al, it is possible that these seed crystals are a further source for Al₂O₃ in the mixture prepared in (i).

Depending on the specific synthesis process, it is possible that one or more suitable alkali metal sources are present in the mixture prepared in (i). In this case, it may be preferred that the mixture prepared in (i) further comprises a compound comprising an alkali metal M in an amount so that for M expressed as M₂O, the mixture exhibits a molar ratio (d M₂O):(a Al₂O₃+SiO₂) wherein d is a number in the range of from 0 to 0.6. Possible ranges are, for example, from 0.01 to 0.2 or from 0.1 to 0.3 or from 0.2 to 0.4 or from 0.3 to 0.5 or from 0.4 to 0.6. While there are no specific restrictions concerning the chemical nature of the alkali metal, it is preferred that the alkali metal M comprises, preferably is, sodium, wherein the compound comprising sodium preferably comprises one or more of NaOH, a sodium aluminate, preferably NaAlO₂, and a sodium silicate, preferably Na₂SiO₃, more preferably Na₂SiO₃×9 H₂O. Thus, it is possible that a given source for SiO₂ or Al₂O₃ is simultaneously a source for or the source for the alkali metal M.

Depending on the specific synthesis process, it is possible that the mixture prepared in (i) comprises seed crystals SC. Preferably, these seed crystals exhibit a zeolitic framework type which allows or assists the crystallization of the desired zeolitic material. Preferably, the mixture prepared in (i) further comprises seed crystals SC comprising, preferably consisting of a zeolitic material having a zeolitic framework structure exhibiting the framework type of the zeolitic material to be prepared. It is possible that the seed crystals also have the chemical composition of the zeolitic material to be prepared, and it is preferred that the mixture prepared in (i) comprises seed crystals SC comprising, preferably consisting of a zeolitic material having the zeolitic framework structure of the zeolitic material to be prepared. It is preferred that the mixture prepared in (i) comprises the seed crystals SC in an amount so that mixture exhibits a weight ratio of the seed crystals SC relative to the mixture prepared in (i) in the range of from 0 to 5%, more preferably in the range of from 0 to 4.5%, more preferably in the range of from 0 to 4%, more preferably in the range of from 0 to 3.5%, more preferably in the range of from 0 to 3%, more preferably in the range of from 0 to 2.5%, more preferably in the range of from 0 to 2 weight-%. If seed crystals are employed, it is preferred that the mixture prepared in (i) comprises the seed crystals SC in an amount so that mixture exhibits a weight ratio of the seed crystals SC relative to the mixture prepared in (i) in the range of from 0.1 to 5%, more preferably in the range of from 0.1 to 4.5%, more preferably in the range of from 0.1 to 4%, more preferably in the range of from 0.1 to 3.5%, more preferably in the range of from 0.1 to 3%, more preferably in the range of from 0.1 to 2.5%, more preferably in the range of from 0.1 to 2 weight-%.

Depending on the specific synthesis process, it is possible that the mixture prepared in (i) comprises an organotemplate compound OC for the zeolitic material to be prepared. Preferably, the mixture prepared in (i) comprises the organotemplate compound OC in an amount so that mixture exhibits a molar ratio (f OC):(a Al₂O₃+SiO₂) wherein f is a number in the range of from 0 to 1.5, more preferably in the range of from 0 to 1.25, more preferably in the range of from 0 to 1. If an organotemplate compound is employed, f is a number preferably in the range of from 0.05 to 1.5, more preferably in the range of from 0.1 to 1.25, more preferably in the range of from 0.2 to 1. Alternatively, it is preferred that f is a number in the range of from 0.04 to 0.16, preferably in the range of from 0.06 to 0.15, more preferably in the range of from 0.07 to 0.14, more preferably in the range of from 0.08 to 0.13, more preferably in the range of from 0.09 to 0.12, more preferably in the range of from 0.1 to 0.11.

The specific chemical nature of the organotemplate compound OC depends on the specific zeolitic material to be prepared or the crystalline precursor thereof to be prepared. Typically, but not limiting, it is preferred that if, for example, the framework type of the zeolitic material is CDO, the organotemplate compound OC comprises, preferably is, diethyldimethylammonium hydroxide; if, for example, the framework type of the zeolitic material is MFI, the organotemplate compound OC comprises, preferably is, tetrapropylammonium bromide or tetrapropylammonium hydroxide; if, for example, the framework type of the zeolitic material is CHA, the organotemplate compound OC comprises, preferably is, N,N,N-trimethyladamantylammonium hydroxide; if, for example, the framework type of the zeolitic material is BEA, the organotemplate compound OC comprises, preferably is, tetraethylammonium hydroxide; if, for example, the framework type of the zeolitic material is MOR, the organotemplate compound OC comprises, preferably is, tetraethylammonium hydroxide or tetraethylammonium bromide.

Generally, it may conceivable that in addition to the compounds described above, the mixture prepared in (i) contains one or more additional compounds. Preferably, at least 99 weight-%, more preferably at least 99.5 weight-%, more preferably at least 99.9 weight-% of the mixture prepared in (i) consist of H₂O, the one or more compounds comprising Si from which SiO₂ in the zeolitic framework structure is formed, optionally the one or more compounds comprising Al from which Al₂O₃ in the zeolitic framework structure is formed, optionally the compound comprising an alkali metal M, optionally the seed crystals SC and optionally the organotemplate compound OC. It is preferred that the mixture prepared in (i) essentially consists of H₂O, the one or more compounds comprising Si from which SiO₂ in the zeolitic framework structure is formed, optionally the one or more compounds comprising Al from which Al₂O₃ in the zeolitic framework structure is formed, optionally the compound comprising an alkali metal M, optionally the seed crystals SC and optionally the organotemplate compound OC.

With regard to the preparation of the mixture according to (i), no specific restrictions exist provided that the respective components of the mixture are sufficiently homogenously mixed. Every conceivable method for achieving such a homogenous mixture is possible. Preferably, preparing the mixture in (i) comprises grinding. Depending on the respective volume of the mixture, the grinding time will vary. Typically, the is carried out for a time in the range of from 0.1 to 30 min, preferably in the range of from 0.5 to 20 min, more preferably in the range of from 1 to 15 min. Generally, the grinding can be carried out at any suitable temperature, such as at room temperature, at elevated temperature compared to room temperature, or at temperatures lower than room temperature. Typically, the grinding is carried out at a temperature of the mixture in the range of from 10 to 50° C., preferably in the range of from 15 to 40° C., more preferably in the range of from 20 to 30° C.

The mixture prepared according to (i) is then subjected to crystallization according to (i). Preferably, the mixture prepared according to (i) is not subjected to any intermediate step prior to (ii) wherein the chemical composition of the mixture is changed.

The crystallization according to (ii) can be carried out in any suitable vessel. Preferably, subjecting the mixture obtained in (i) to crystallization according to (ii) is carried out in a pressure-tight vessel, preferably in an autoclave. Preferably, subjecting the mixture obtained in (i) to crystallization according to (ii) is carried out under autogenous pressure. During crystallization, it is preferred that the mixture is stirred wherein stirring can be carried during the whole crystallization period or only during a part of the crystallization period.

The mixture prepared in (i) is suitably heated to the desired crystallization temperature. Preferably, the heating of the mixture is carried out in the vessel in which the crystallization is carried out. The heating rate can be suitably adjusted, for example to the dimensions of the vessel, the amount of the mixture to be heated, and the like. Preferably, subjecting the mixture obtained in (i) to crystallization comprises heating the mixture to the crystallization temperature at a heating rate in the range of from 1 to 20 K/min, more preferably in the range of from 1 to 15 K/min, more preferably in the range of from 1 to 10 K/min, more preferably in the range of from 1 to 5 K/min.

According to the present invention, it was found that the crystallization can be carried out at very high crystallization temperatures, thus allowing for achieving a very short crystallization time and, consequently, a very high space-time yield which makes the inventive process very attractive for industrial-scale preparation processes.

Preferably, the crystallization temperature according to (ii) is in the range of from 200 to 350° C., more preferably in the range of from 200 to 300° C., more preferably in the range of from 200 to 250° C., more preferably in the range of from 200 to 240° C. Further, depending on the specific zeolitic material or precursor thereof, the crystallization temperature according to (ii) is preferably in the range of from 210 to 350° C., more preferably in the range of from 210 to 300° C., more preferably in the range of from 210 to 250° C., more preferably in the range of from 210 to 240° C. Yet further, depending on the specific zeolitic material or precursor thereof, the crystallization temperature according to (ii) is preferably in the range of from 210 to 350° C., more preferably in the range of from 260 to 350° C. Further, depending on the specific zeolitic material or precursor thereof, it is alternatively preferred that the crystallization temperature according to (ii) is in the range of from 140 to 325° C., preferably at a crystallization temperature in the range of from 180 to 300° C., more preferably at a crystallization temperature in the range of from 200 to 275° C., more preferably at a crystallization temperature in the range of from 240 to 250° C.

The crystallization time according to (ii) is preferably in the range of from 0.15 to 42 h, more preferably in the range of from 0.2 to 36 h. Depending on the specific zeolitic material or precursor thereof, for example for zeolitic materials having framework type BEA, MFI, MOR or CHA, the crystallization time is preferably in the range of from 0.15 to 12 h, more preferably in the range of from 0.2 to 6 h, more preferably in the range of from 0.2 to 3 h, more preferably in the range of from 0.2 to 2 h. Further, depending on the specific zeolitic material or precursor thereof, for example for a zeolitic material precursor having the RUB-36 structure, the crystallization time is preferably in the range of from 0.15 to 42 h, more preferably in the range of from 0.2 to 36 h.

Depending on the zeolitic material or precursor thereof, the space-time yield of the crystallization according to (ii) is in the range of from 100 to 150,000 kg/m³/d, wherein the space-time yield is defined as the mass/kg of the zeolitic material or the crystalline precursor obtained from (ii) divided by the volume/m³ of the mixture prepared in (i) divided by the crystallization time/d according to (ii).

In particular, with regard to zeolitic materials having framework type BEA, the crystallization temperature according to (ii) is preferably in the range of from 190 to 350° C., more preferably in the range of from 190 to 300° C., more preferably in the range of from 190 to 250° C. More preferably, the crystallization temperature according to (ii) is in the range of from 200 to 250° C., more preferably in the range of from 210 to 250° C., more preferably in the range of from 230 to 250° C. It is conceivable that the crystallization temperature is in the range of from 210 to 350° C. or in the range of from 260 to 350° C. The crystallization time is preferably in the range of from 0.1 to 12 h, more preferably in the range of from 0.15 to 9 h, more preferably in the range of from 0.2 to 6 h. More preferably, the crystallization time is in the range of from 0.3 to 4 h, more preferably in the range of from 0.4 to 3 h, more preferably in the range of from 0.5 to 2 h. Preferably, the space-time yield of the crystallization according to (ii) is in the range of from 500 to 60,000 kg/m³/d, more preferably in the range of from 750 to 10,000 kg/m³/d, more preferably in the range of from 1,000 to 2,500 kg/m³/d. Therefore, the present invention relates to a process for preparing a zeolitic material having a zeolitic framework structure which exhibits a molar ratio (a Al₂O₃):SiO₂ and which has zeolitic framework type BEA, wherein a is a number in the range of from 0 to 0.5, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
(ii) subjecting the mixture obtained in (i) to crystallization at a crystallization temperature in the range of from 230 to 250° C. and for a crystallization time in the range of from 0.5 to 2 h, obtaining the zeolitic material having a zeolitic framework structure which exhibits a molar ratio (a Al₂O₃):SiO₂.

In particular, with regard to zeolitic materials having framework type MOR, the crystallization temperature according to (ii) is preferably in the range of from 190 to 350° C., more preferably in the range of from 190 to 300° C., more preferably in the range of from 190 to 250° C. More preferably, the crystallization temperature according to (ii) is in the range of from 200 to 250° C., more preferably in the range of from 210 to 250° C., more preferably in the range of from 230 to 250° C. It is conceivable that the crystallization temperature is in the range of from 210 to 350° C. or in the range of from 260 to 350° C. The crystallization time is preferably in the range of from 0.1 to 12 h, more preferably in the range of from 0.15 to 9 h, more preferably in the range of from 0.2 to 6 h. More preferably, the crystallization time is in the range of from 0.3 to 4 h, more preferably in the range of from 0.5 to 3 h, more preferably in the range of from 1 to 2 h. Preferably, the space-time yield of the crystallization according to (ii) is in the range of from 500 to 20,000 kg/m³/d, more preferably in the range of from 1,000 to 10,000 kg/m³/d, more preferably in the range of from 2,000 to 5,000 kg/m³/d. Therefore, the present invention relates to a process for preparing a zeolitic material having a zeolitic framework structure which exhibits a molar ratio (a Al₂O₃):SiO₂ and which has zeolitic framework type MOR, wherein a is a number in the range of from 0 to 0.5, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
(ii) subjecting the mixture obtained in (i) to crystallization at a crystallization temperature in the range of from 230 to 250° C. and for a crystallization time in the range of from 1 to 2 h, obtaining the zeolitic material having a zeolitic framework structure which exhibits a molar ratio (a Al₂O₃):SiO₂.

In particular, with regard to zeolitic materials having framework type MFI, the crystallization temperature according to (ii) is preferably in the range of from 140 to 350° C., more preferably 190 to 350° C., more preferably in the range of from 190 to 300° C., more preferably in the range of from 190 to 250° C. More preferably, the crystallization temperature according to (ii) is in the range of from 200 to 250° C., more preferably in the range of from 210 to 250° C., more preferably in the range of from 230 to 250° C. Alternatively, it is preferred that the crystallization temperature according to (ii) is in the range of from 140 to 325° C., preferably at a crystallization temperature in the range of from 180 to 300° C., more preferably at a crystallization temperature in the range of from 200 to 275° C., more preferably at a crystallization temperature in the range of from 240 to 250° C.

It is conceivable that the crystallization temperature is in the range of from 210 to 350° C. or in the range of from 260 to 350° C. The crystallization time is preferably in the range of from 0.1 to 12 h, more preferably in the range of from 0.2 to 5 h, more preferably in the range of from 0.1 to 2 h. Alternatively, it is preferred that the crystallization time is in the range of from 20 to 350 minutes, more preferably in the range of from 30 to 300 minutes, more preferably in the range of 40 to 250 minutes, more preferably in the range of 50 to 200 minutes, more preferably in the range of from 60 to 150 minutes, more preferably in the range of from 70 to 120 minutes, more preferably in the range of from 75 to 110 minutes, more preferably in the range of from 80 to 100 minutes, more preferably in the range of from 85 to 95 minutes. Preferably, the space-time yield of the crystallization according to (ii) is in the range of from 5,000 to 60,000 kg/m³/d, more preferably in the range of from 7,500 to 30,000 kg/m³/d, more preferably in the range of from 10,000 to 15,000 kg/m³/d. Therefore, the present invention relates to a process for preparing a zeolitic material having a zeolitic framework structure which exhibits a molar ratio (a Al₂O₃):SiO₂ and which has zeolitic framework type MFI, wherein a is a number in the range of from 0 to 0.5, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
(ii) subjecting the mixture obtained in (i) to crystallization at a crystallization temperature in the range of from 230 to 250° C. and for a crystallization time in the range of from 1 to 2 h, obtaining the zeolitic material having a zeolitic framework structure which exhibits a molar ratio (a Al₂O₃):SiO₂.

In particular, with regard to zeolitic materials having framework type CHA, the crystallization temperature according to (ii) is preferably in the range of from 190 to 350° C., more preferably in the range of from 190 to 300° C., more preferably in the range of from 190 to 250° C. More preferably, the crystallization temperature according to (ii) is in the range of from 200 to 250° C., more preferably in the range of from 210 to 250° C., more preferably in the range of from 230 to 250° C. It is conceivable that the crystallization temperature is in the range of from 210 to 350° C. or in the range of from 260 to 350° C. The crystallization time is preferably in the range of from 0.1 to 12 h, more preferably in the range of from 0.15 to 9 h, more preferably in the range of from 0.2 to 5 h. More preferably, the crystallization time is in the range of from 0.3 to 4 h, more preferably in the range of from 0.5 to 3 h, more preferably in the range of from 1 to 2 h. Preferably, the space-time yield of the crystallization according to (ii) is in the range of from 2,000 to 40,000 kg/m³/d, more preferably in the range of from 1,500 to 15,000 kg/m³/d, more preferably in the range of from 3,000 to 6,000 kg/m³/d. Therefore, the present invention relates to a process for preparing a zeolitic material having a zeolitic framework structure which exhibits a molar ratio (a Al₂O₃):SiO₂ and which has zeolitic framework type CHA, wherein a is a number in the range of from 0 to 0.5, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
(ii) subjecting the mixture obtained in (i) to crystallization at a crystallization temperature in the range of from 230 to 250° C. and for a crystallization time in the range of from 1 to 2 h, obtaining the zeolitic material having a zeolitic framework structure which exhibits a molar ratio (a Al₂O₃):SiO₂.

In particular, with regard to crystalline zeolitic material precursor having the RUB-36 structure, the crystallization temperature according to (ii) is preferably in the range of from 165° C. to 350° C., more preferably in the range of from 170 to 350° C., more preferably in the range of from 175 to 350° C., more preferably in the range of from 180 to 3500° C., more preferably in the range of from 185 to 350° C., more preferably in the range of from 190 to 350° C., more preferably in the range of from 190 to 300° C., more preferably in the range of from 190 to 250° C. More preferably, the crystallization temperature according to (ii) is in the range of from 190 to 220° C., more preferably in the range of from 190 to 210° C., more preferably in the range of from 195 to 205° C. It is conceivable that the crystallization temperature is in the range of from 210 to 350° C. or in the range of from 260 to 350° C. The crystallization time is preferably in the range of from 0.1 to 48 h, more preferably in the range of from 0.2 to 42 h, more preferably in the range of from 0.5 to 36 h. More preferably, the crystallization time is in the range of from 12 to 48 h, more preferably in the range of from 18 to 42 h, more preferably in the range of from 24 to 36 h. Preferably, the space-time yield of the crystallization according to (ii) is in the range of from 100 to 1,000 kg/m³/d, more preferably in the range of from 125 to 500 kg/m³/d, more preferably in the range of from 150 to 250 kg/m³/d. Therefore, the present invention relates to a process for preparing a crystalline precursor of zeolitic material having a zeolitic framework structure which exhibits a molar ratio (a Al₂O₃):SiO₂, wherein the precursor has RUB-36 structure, wherein a is a number in the range of from 0 to 0.5, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
(ii) subjecting the mixture obtained in (i) to crystallization at a crystallization temperature in the range of from 190 to 210° C. and for a crystallization time in the range of from 24 to 36 h, obtaining the crystalline precursor.

With regard to the crystalline zeolitic material precursor having the RUB-36 structure, it is preferred that a is 0. Preferably, c is in the range of from 0 to 2, preferably in the range of from 0.5 to 1.75, more preferably in the range of from 1.0 to 1.5. Therefore, the present invention relates to a process for preparing a crystalline precursor of zeolitic material having a zeolitic framework structure which exhibits a molar ratio (a Al₂O₃):SiO₂, wherein the precursor has RUB-36 structure, wherein a is 0, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 1.0 to 1.5;
(ii) subjecting the mixture obtained in (i) to crystallization at a crystallization temperature in the range of from 190 to 210° C. and for a crystallization time in the range of from 24 to 36 h, obtaining the crystalline precursor.

In particular for the crystalline precursor having the RUB-36 structure, it was found that comparatively low amounts of organotemplate compound has to be used. For example, the ratio of DMDEA⁺ to SiO₂ in the hydrothermal synthesis of RUB-36 according to Comparative Example 1 is 0.43:1, while this ratio under the solidothermal conditions according to the present invention is, according to a preferred embodiment according to Example 1, only 0.15:1 This advantages is additionally important for an industrial production process. It is preferred that the mixture prepared in (i) further comprises an organotemplate compound OC which comprises diethyldimethylammonium hydroxide, and wherein the mixture prepared in (i) comprises the organotemplate compound OC in an amount so that mixture exhibits a molar ratio (f OC):(a Al₂O₃+SiO₂) wherein f is a number in the range of from 0.05 to 0.3, preferably in the range of from 0.05 to 0.25, more preferably in the range of from 0.05 to 0.2. Therefore, the present invention relates to a process for preparing a crystalline precursor of zeolitic material having a zeolitic framework structure which exhibits a molar ratio (a Al₂O₃):SiO₂, wherein the precursor has RUB-36 structure, wherein a is a number in the range of from 0 to 0.5, preferably 0, said process comprising
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0, preferably in the range of from 1.0 to 1.5, wherein the mixture prepared in (i) further comprises an organotemplate compound OC which preferably comprises diethyldimethylammonium hydroxide, and wherein the mixture prepared in (i) comprises the organotemplate compound OC in an amount so that mixture exhibits a molar ratio (f OC):(a Al₂O₃+SiO₂) wherein f is a number in the range of from 0.05 to 0.3, preferably in the range of from 0.05 to 0.25, more preferably in the range of from 0.05 to 0.2;
(ii) subjecting the mixture obtained in (i) to crystallization at a crystallization temperature in the range of from 165 to 350° C., preferably in the range of from 190 to 210° C. and for a crystallization time in the range of from 0.2 to 36 h, preferably in the range of from 24 to 36 h, obtaining the crystalline precursor.

In particular, the present invention relates to a crystalline precursor of zeolitic material having a zeolitic framework structure which exhibits a molar ratio (a Al₂O₃):SiO₂, wherein the precursor has RUB-36 structure, wherein a is a number in the range of from 0 to 0.5, wherein the precursor is obtainable or obtained by a process as described above. Further, it was found that, compared to RUB-36 materials described in the prior art which are prepared by conventional hydrothermal synthesis, the inventive RUB-36 materials have higher silica condensation degree, indicated by the respective Q4:Q3 ratios determined according to ³¹Si NMR. Such a high silica condensation degree is very favorable for enhancement of thermal and hydrothermal stabilities of porous materials. Therefore, the present invention also relates to a crystalline precursor of zeolitic material having a zeolitic framework structure which exhibits a molar ratio (a Al₂O₃):SiO₂, wherein the precursor has RUB-36 structure, wherein a is a number in the range of from 0 to 0.5, wherein said precursor exhibits a Q4:Q3 ratio determined according to ³¹Si NMR as described in Reference Example 1 herein, wherein Q4:Q3 is at least 72.0:28:0, preferably at most least 73.0:27:0, more preferably at least 74.0:26.0, more preferably at least 74.5:25.0.

Depending on the zeolitic material or the crystalline precursor thereof, it may be preferred that after the crystallization according to (ii), the zeolitic material or the precursor thereof is subjected to ion exchange. No specific restrictions exist regarding the chemical nature of the ion. For example the ion is the ammonium ion.

Depending on the zeolitic material or the crystalline precursor thereof, it may be preferred that after the crystallization according to (ii), optionally after the ion exchange described above, the zeolitic material or the crystalline precursor thereof is calcined. Preferably, the calcination is carried out using a gas stream having a temperature in the range of from 400 to 600° C., preferably in the range of from 450 to 550° C. Preferably, the gas stream is one or more of oxygen, nitrogen, air, and lean air. Typical calcination times depend on the amount of material to be calcined and/or the apparatus used for the calcination. Calcination times may be in the range of from 0.5 to 12 h, in the range of from 1 to 9 h, or in the range of from 2 to 6 h.

Depending on the zeolitic material or the crystalline precursor thereof, it may be preferred that after the calcination, according to (ii), the zeolitic material or the precursor thereof is subjected to ion exchange, optionally a further ion exchange.

Further, the present invention also relates to a zeolitic material having a zeolitic framework structure which exhibits a molar ratio (a Al₂O₃):SiO₂ or a crystalline precursor thereof, which is obtainable or obtained by a process as described above, wherein a is a number in the range of from 0 to 0.5. No specific restrictions exist regarding potential uses of said zeolitic material having a zeolitic framework structure or the precursor thereof. Preferably, the zeolitic material or the precursor thereof is used as an absorbent, an ion exchanger, an adsorbent, a catalyst or a precursor thereof, preferably as a catalyst component or a precursor thereof, and/or as a catalyst support or a precursor thereof. More preferably, the zeolitic material or the precursor thereof is used as a catalyst or a precursor thereof for the methanol-to-olefins (MTO) reaction, wherein preferably the zeolitic material has an MFI framework structure.

The present invention is further illustrated by the following set of embodiments and combinations of embodiments resulting from the given dependencies and back-references.
1. A process for preparing a zeolitic material having a zeolitic framework structure which exhibits a molar ratio (a Al₂O₃):SiO₂ or a crystalline precursor thereof, wherein a is a number in the range of from 0 to 0.5, said process comprising
   (i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
   (ii) subjecting the mixture obtained in (i) to crystallization at a crystallization temperature in the range of from 110 to 350° C., preferably in the range of from 190 to 350° C., and for a crystallization time in the range of from 0.1 to 48 h, obtaining the zeolitic material having a zeolitic framework structure which exhibits a molar ratio (a Al₂O₃):SiO₂ or the crystalline precursor thereof.
2. The process of embodiment 1, wherein a is in the range of from 0 to 0.4, preferably in the range of from 0 to 0.3, more preferably in the range of from 0 to 0.2.
3. The process of embodiment 1 or 2, wherein a is 0.
4. The process of embodiment 1 or 2, wherein a is in the range of from 0.001 to 0.5, preferably in the range of from 0.002 to 0.4, more preferably in the range of from 0.003 to 0.3, more preferably in the range of from 0.004 to 0.2.
5. The process of embodiment 3, wherein the zeolitic framework structure of the zeolitic material exhibits framework type MFI or wherein the crystalline precursor has the RUB-36 structure.
6. The process of any one of embodiments 1 to 4, wherein the zeolitic framework structure of the zeolitic material exhibits framework type ABW, ACO, AEI, AEL, AEN, AET, AFG, AFI, AFN, AFO, AFR, AFS, AFT, AFV, AFX, AFY, AHT, ANA, APC, APD, AST, ASV, ATN, ATO, ATS, ATT, ATV, AVL, AWO, AWW, BCT, BEA, BEC, BIK, BOF, BOG, BOZ, BPH, BRE, BSV, CAN, CAS, CDO, CFI, CGF, CGS, CHA, -CHI, -CLO, CON, CSV, CZP, DAC, DDR, DFO, DFT, DOH, DON, EAB, EDI, EEl, EMT, EON, EPI, ERI, ESV, ETR, EUO, *-EWT, EZT, FAR, FAU, FER, FRA, GIS, GIU, GME, GON, GOO, HEU, IFO, IFR, -IFU, IFW, IFY, IHW, IMF, IRN, IRR, -IRY, ISV, ITE, ITG, ITH, *-ITN, ITR, ITT, -ITV, ITW, IWR, IWS, IWV, IWW, JBW, JNT, JOZ, JRY, JSN, JSR, JST, JSW, KFI, LAU, LEV, LIO, -LIT, LOS, LOV, LTA, LTF, LTJ, LTL, LTN, MAR, MAZ, MEI, MEL, MEP, MER, MFI, MFS, MON, MOR, MOZ, *MRE, MSE, MSO, MTF, MTN, MTT, MTW, MVY, MWF, MWW, NAB, NAT, NES, NON, NPO, NPT, NSI, OBW, OFF, OKO, OSI, OSO, OWE, -PAR, PAU, PCR, PHI, PON, POS, PSI, PUN, RHO, —RON, RRO, RSN, RTE, RTH, RUT, RWR, RWY, SAF, SAO, SAS, SAT, SAV, SBE, SBN, SBS, SBT, SEW, SFE, SFF, SFG, SFH, SFN, SFO, SFS, *SFV, SFW, SGT, SIV, SOD, SOF, SOS, SSF, *-SSO, SSY, STF, STI, *STO, STT, STW, -SVR, SW, SZR, TER, THO, TOL, TON, TSC, TUN, UEI, UFI, UOS, UOV, UOZ, USI, UTL, UWY, VET, VFI, VNI, VSV, WEI, -WEN, YUG, ZON, or a mixed type of two or more thereof, preferably framework type BEA, CHA, MFI, MEL, MOR, CDO, AEI, FER, SAV, or a mixed type of two or more thereof, more preferably framework type BEA, CHA, MFI, MOR, or CDO, more preferably framework type MFI.
7. The process of any one of embodiments 1 to 6, wherein the zeolitic framework structure of the zeolitic material does not exhibit framework type MWW.
8. The process of any one of embodiments 1 to 7, wherein c is in the range of from 0.01 to 2.4, preferably in the range of from 0.03 to 2.2, more preferably in the range of from 0.05 to 2.0.
9. The process of any one of embodiments 1 to 7, wherein c is in the range of from 0.1 to 2.4, preferably in the range of from 0.2 to 2.4, more preferably in the range of from 0.3 to 2.4, more preferably in the range of from 0.4 to 2.2, more preferably in the range of from 0.5 to 2.0, more preferably in the range of from 0.6 to 1.8, more preferably in the range of from 0.7 to 1.6, more preferably in the range of from 0.8 to 1.4, more preferably in the range of from 0.9 to 1.2.
10. The process of any one of embodiments 1 to 9, wherein b is in the range of from 0.01 to 2, preferably in the range of from 0.1 to 2, more preferably in the range of from 0.5 to 2.
11. The process of any one of embodiments 1 to 9, wherein b is in the range of from 0.1 to 2, more preferably in the range of from 0.2 to 2, more preferably in the range of from 0.3 to 2, more preferably in the range of from 0.4 to 2, more preferably in the range of from 0.5 to 2, more preferably in the range of from 0.6 to 1.8, more preferably in the range of from 0.7 to 1.6, more preferably in the range of from 0.8 to 1.4, more preferably in the range of from 0.9 to 1.2.
12. The process of any one of embodiments 1 to 11, wherein the mixture prepared in (i) comprises one compound comprising Si from which SiO₂ in the zeolitic framework structure is formed, wherein this compound is the silica gel exhibiting a molar ratio (c H₂O):SiO₂.
13. The process of any one of embodiments 1 to 11, wherein the mixture prepared in (i) comprises two or more compounds comprising Si from which SiO₂ in the zeolitic framework structure is formed, preferably comprises two compounds comprising Si from which SiO₂ in the zeolitic framework structure is formed.
14. The process of embodiment 13, wherein the two or more compounds comprising Si from which SiO₂ in the zeolitic framework structure is formed, preferably the two compounds comprising Si from which SiO₂ in the zeolitic framework structure is formed, comprise a sodium silicate, a white carbon black, an amorphous silica powder, or a fumed silica, preferably a sodium silicate and/or a fumed silica, more preferably a Na₂SiO₃ and/or fumed silica, more preferably Na₂SiO₃×9 H₂O and/or a fumed silica.
15. The process of embodiment 14, wherein the two compounds comprising Si from which SiO₂ in the zeolitic framework structure is formed are the silica gel exhibiting a molar ratio (c H₂O):SiO₂ and the sodium silicate, preferably the Na₂SiO₃, more preferably the Na₂SiO₃×9 H₂O.
16. The process of any one of embodiments 1 to 15, wherein the one or more compounds comprising Al from which Al₂O₃ in the zeolitic framework structure is formed comprise one or more of an aluminum sulfate, preferably Al₂(SO₄)₃, a sodium aluminate, preferably NaAlO₂, and a boehmite.
17. The process of any one of embodiments 1 to 16, wherein the mixture prepared in (i) further comprises a compound comprising an alkali metal M in an amount so that for M expressed as M₂O, the mixture exhibits a molar ratio (d M₂O):(a Al₂O₃+SiO₂) wherein d is a number in the range of from 0 to 0.6.
18. The process of embodiment 17, wherein the alkali metal M comprises, preferably is, sodium, wherein the compound comprising sodium preferably comprises one or more of sodium hydroxide, a sodium aluminate, preferably NaAlO₂, and a sodium silicate, preferably Na₂SiO₃, more preferably Na₂SiO₃×9 H₂O.
19. The process of any one of embodiments 1 to 18, wherein the mixture prepared in (i) further comprises seed crystals SC comprising, preferably consisting of a zeolitic material having a zeolitic framework structure exhibiting the framework type of the zeolitic material to be prepared or comprising, preferably consisting of a crystalline material having the structure of the crystalline precursor material to be prepared.
20. The process of embodiment 19, wherein the mixture prepared in (i) further comprises seed crystals SC comprising, preferably consisting of a zeolitic material having the zeolitic framework structure of the zeolitic material to be prepared, or comprising, preferably consisting of a crystalline material having the structure of the crystalline material to be prepared.
21. The process of embodiment 19 or 20, wherein the mixture prepared in (i) comprises the seed crystals SC in an amount so that mixture exhibits a weight ratio of the seed crystals SC relative to the mixture prepared in (i) in the range of from 0 to 5%, preferably in the range of from 0 to 3.5%, more preferably in the range of from 0 to 2 weight-%.
22. The process of any one of embodiments 1 to 21, wherein the mixture prepared in (i) further comprises an organotemplate compound OC for the zeolitic material to be prepared.
23. The process of embodiment 22, wherein the mixture prepared in (i) comprises the organotemplate compound OC in an amount so that mixture exhibits a molar ratio (f OC):(a Al₂O₃+SiO₂) wherein f is a number in the range of from 0 to 1.5, preferably in the range of from 0.1 to 1.25, more preferably in the range of from 0.2 to 1.
24. The process of embodiment 22, wherein the mixture prepared in (i) comprises the organotemplate compound OC in an amount so that mixture exhibits a molar ratio (f OC):(a Al₂O₃+SiO₂) wherein f is a number in the range of from 0.04 to 0.16, preferably in the range of from 0.06 to 0.15, more preferably in the range of from 0.07 to 0.14, more preferably in the range of from 0.08 to 0.13, more preferably in the range of from 0.09 to 0.12, more preferably in the range of from 0.1 to 0.11.
25. The process of any one of embodiments 22 to 24, wherein, if the framework type of the zeolitic material is CDO, the organotemplate compound OC comprises, preferably is, diethyldimethylammonium hydroxide; if the framework type of the zeolitic material is MFI, the organotemplate compound OC comprises, preferably is, tetrapropylammonium bromide or tetrapropylammonium hydroxide; if the framework type of the zeolitic material is CHA, the organotemplate compound OC comprises, preferably is, N,N,N-trimethyladamantylammonium hydroxide; if the framework type of the zeolitic material is BEA, the organotemplate compound OC comprises, preferably is, tetraethylammonium hydroxide; if the framework type of the zeolitic material is MOR, the organotemplate compound OC comprises, preferably is, tetraethylammonium hydroxide or tetraethylammonium bromide.
26. The process of any one of embodiments 1 to 24, wherein at least 99 weight-%, more preferably at least 99.5 weight-%, more preferably at least 99.9 weight-% of the mixture prepared in (i) consist of H₂O, the one or more compounds comprising Si from which SiO₂ in the zeolitic framework structure is formed, optionally the one or more compounds comprising Al from which Al₂O₃ in the zeolitic framework structure is formed, optionally the compound comprising an alkali metal M, optionally the seed crystals SC and optionally the organotemplate compound OC.
27. The process of any one of embodiments 1 to 26, wherein preparing the mixture in
   (i) comprises grinding.
28. The process of embodiment 27, wherein the grinding is carried out for a time in the range of from 0.1 to 30 min, preferably in the range of from 0.5 to 20 min, more preferably in the range of from 1 to 15 min.
29. The process of embodiment 27 or 28, wherein the grinding is carried out at a temperature of the mixture in the range of from 10 to 50° C., preferably in the range of from 15 to 40° C., more preferably in the range of from 20 to 30° C.
30. The process of any one of embodiments 1 to 29, wherein subjecting the mixture obtained in (i) to crystallization according to (ii) is carried out in a pressure-tight vessel, preferably in an autoclave, preferably under autogenous pressure.
31. The process of any one of embodiments 1 to 30, wherein subjecting the mixture obtained in (i) to crystallization according to (ii) comprises stirring the mixture.
32. The process of any one of embodiments 1 to 31, wherein subjecting the mixture obtained in (i) to crystallization comprises heating the mixture to the crystallization temperature at a heating rate in the range of from 1 to 20 K/min, preferably in the range of from 1 to 10 K/min, more preferably in the range of from 1 to 5 K/min.
33. The process of any one of embodiments 1 to 32, wherein the crystallization temperature according to (ii) is in the range of from 140 to 325° C., preferably at a crystallization temperature in the range of from 180 to 300° C., more preferably at a crystallization temperature in the range of from 200 to 275° C., more preferably at a crystallization temperature in the range of from 240 to 250° C.
34. The process of any one of embodiments 1 to 32, wherein the crystallization temperature according to (ii) is in the range of from 200 to 350° C., preferably in the range of from 200 to 300° C., more preferably in the range of from 200 to 250° C., more preferably in the range of from 200 to 240° C.
35. The process of any one of embodiments 1 to 32, wherein the crystallization temperature according to (ii) is in the range of from 210 to 350° C., preferably in the range of from 210 to 300° C., more preferably in the range of from 210 to 250° C., more preferably in the range of from 210 to 240° C.
36. The process of any one of embodiments 1 to 32, wherein the crystallization temperature according to (ii) is in the range of from 210 to 350° C., preferably in the range of from 260 to 350° C.
37. The process of any one of embodiments 1 to 36, wherein the crystallization time according to (ii) is in the range of from 0.2 to 36 h.
38. The process of any one of embodiments 1 to 37, wherein the space-time yield of the crystallization according to (ii) is in the range of from 100 to 150,000 kg/m³/d, wherein the space-time yield is defined as the mass/kg of the zeolitic material or the crystalline precursor obtained from (ii) divided by the volume/m³ of the mixture prepared in (i) divided by the crystallization time/d according to (ii).
39. The process of any one of embodiments 1 to 32, wherein the zeolitic material has a zeolitic framework structure exhibiting framework type BEA, wherein the crystallization temperature according to (ii) is in the range of from 190 to 240° C., preferably in the range of from 200 to 240° C.
40. The process of embodiment 39, wherein the crystallization time according to (ii) is in the range of from 0.2 to 6 h, preferably in the range of from 0.5 to 2 h.
41. The process of embodiment 39 or 40, wherein the space-time yield of the crystallization according to (ii) is in the range of from 500 to 60,000 kg/m³/d, preferably in the range of from 1,000 to 2,500 kg/m³/d.
42. The process of any one of embodiments 1 to 32, wherein the zeolitic material has a zeolitic framework structure exhibiting framework type MOR, wherein the crystallization temperature according to (ii) is in the range of from 200 to 250° C., preferably in the range of from 230 to 250° C.
43. The process of embodiment 42, wherein the crystallization time according to (ii) is in the range of from 0.2 to 6 h, preferably in the range of from 1 to 2 h.
44. The process of embodiment 42 or 43, wherein the space-time yield of the crystallization according to (ii) is in the range of from 500 to 20,000 kg/m³/d, preferably in the range of from 2000 to 5,000 kg/m³/d.
45. The process of any one of embodiments 1 to 32, wherein the zeolitic material has a zeolitic framework structure exhibiting framework type MFI, wherein the crystallization temperature according to (ii) is in the range of from 200 to 250° C., preferably in the range of from 230 to 250° C.
46. The process of embodiment 45, wherein the crystallization time according to (ii) is in the range of from 0.2 to 5 h, preferably in the range of from 0.2 to 1 h.
47. The process of embodiments 1 to 32, wherein the zeolitic material has a zeolitic framework structure exhibiting framework type MFI, and wherein the crystallization temperature according to (ii) is in the range of from 140 to 325° C., preferably at a crystallization temperature in the range of from 180 to 300° C., more preferably at a crystallization temperature in the range of from 200 to 275° C., more preferably at a crystallization temperature in the range of from 240 to 250° C.
48. The process of embodiment 47, wherein the crystallization time according to (ii) is in the range of from 20 to 350 minutes, more preferably in the range of from 30 to 300 minutes, more preferably in the range of 40 to 250 minutes, more preferably in the range of 50 to 200 minutes, more preferably in the range of from 60 to 150 minutes, more preferably in the range of from 70 to 120 minutes, more preferably in the range of from 75 to 110 minutes, more preferably in the range of from 80 to 100 minutes, more preferably in the range of from 85 to 95 minutes.
49. The process of embodiment 47 or 48, wherein the space-time yield of the crystallization according to (ii) is in the range of from 5000 to 60,000 kg/m³/d, preferably in the range of from 10,000 to 15,000 kg/m³/d.
50. The process of any one of embodiments 1 to 32, wherein the zeolitic material has a zeolitic framework structure exhibiting framework type CHA, wherein the crystallization temperature according to (ii) is in the range of from 200 to 250° C., preferably in the range of from 230 to 250° C.
51. The process of embodiment 50, wherein the crystallization time according to (ii) is in the range of from 0.2 to 5 h, preferably in the range of from 1 to 2 h.
52. The process of embodiment 50 or 51, wherein the space-time yield of the crystallization according to (ii) is in the range of from 2,000 to 150,000 kg/m³/d, preferably in the range of from 3,000 to 80,000 kg/m³/d.
53. The process of any one of embodiments 1 to 32, wherein the crystalline precursor has the RUB-36 structure, wherein the crystallization temperature according to (ii) is in the range of from 190 to 240° C., preferably in the range of from 190 to 220° C., more preferably in the range of from 190 to 210° C., more preferably in the range of from 195 to 205° C.
54. The process of embodiment 53, wherein the crystallization time according to (ii) is in the range of from 12 to 48 h, preferably in the range of from 18 to 42 h, more preferably in the range of from 24 to 36 h.
55. The process of embodiment 53 or 54, wherein the space-time yield of the crystallization according to (ii) is in the range of from 100 to 1000 m³/d, preferably in the range of from 150 to 250 m³/d.
56. The process of any one of embodiments 53 to 55, wherein in the mixture prepared in (i), a is 0.
57. The process of any one of embodiments 53 to 56, wherein in the mixture prepared in (i), c is in the range of from 0 to 2, preferably in the range of from 0.5 to 1.75, more preferably in the range of from 1.0 to 1.5.
58. The process of any one of embodiments 53 to 57, wherein the mixture prepared in (i) further comprises an organotemplate compound OC which comprises diethyldimethylammonium hydroxide, and wherein the mixture prepared in (i) comprises the organotemplate compound OC in an amount so that mixture exhibits a molar ratio (f OC):(a Al₂O₃+SiO₂) wherein f is a number in the range of from 0.05 to 0.3, preferably in the range of from 0.05 to 0.25, more preferably in the range of from 0.05 to 0.2.
59. The process of any one of embodiments 1 to 58, wherein after crystallization according to (ii), the zeolitic material or the precursor thereof is subjected to ion exchange.
60. The process of any one of embodiments 1 to 59, wherein the zeolitic material obtained in (ii) or the crystalline precursor obtained in (ii) is calcined.
61. The process of embodiment 60, wherein the zeolitic material obtained in (ii) or the crystalline precursor obtained in (ii) is calcined in a gas stream having a temperature in the range of from 400 to 600° C., preferably in the range of from 450 to 550° C.
62. The process of embodiment 61, wherein the gas stream is one or more of oxygen, nitrogen, air, and lean air.
63. The process of any one of embodiments 60 to 62, wherein the zeolitic material obtained in (ii) or the crystalline precursor obtained in (ii) is calcined for a calcination time in the range of from 0.5 to 12 h, preferably in the range of from 1 to 9 h, more preferably in the range of from 2 to 6 h.
64. The process of any one of embodiments 60 to 63, wherein after calcination according to (iii), the zeolitic material is subjected to ion exchange.
65. A zeolitic material having a zeolitic framework structure which exhibits a molar ratio (a Al₂O₃):SiO₂ or a crystalline precursor thereof, obtainable or obtained by a process according to any one of embodiments 1 to 64, wherein a is a number in the range of from 0 to 0.5.
66. Use of a zeolitic material or a precursor thereof according to embodiment 65 as an absorbent, an ion exchanger, a catalyst or a precursor thereof, preferably as a catalyst component or a precursor thereof, and/or as a catalyst support or a precursor thereof, more preferably as a catalyst or a precursor thereof for the methanol-to-olefins (MTO) reaction, wherein preferably the zeolitic material has an MFI framework structure.

Specifically, for a crystalline precursor having the RUB-36 structure, the present invention is further illustrated by the following set of embodiments and combinations of embodiments resulting from the given dependencies and back-references.
1. A process for preparing a crystalline precursor of a zeolitic material having a zeolitic framework structure which exhibits a molar ratio (a Al₂O₃):SiO₂ wherein a is a number in the range of from 0 to 0.5, said crystalline precursor having the RUB-36 structure, said process comprising
   (i) preparing a mixture comprising H₂O, one or more compounds comprising Si from which SiO₂ in the zeolitic framework structure is formed, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0;
   (ii) subjecting the mixture obtained in (i) to crystallization at a crystallization temperature in the range of from 165 to 350° C. and for a crystallization time in the range of from 0.1 to 48 h, obtaining the the crystalline precursor thereof.
2. The process of embodiment 1, wherein a is in the range of from 0 to 0.4, preferably in the range of from 0 to 0.3, more preferably in the range of from 0 to 0.2.
3. The process of embodiment 1 or 2, wherein a is 0.
4. The process of any one of embodiments 1 to 3, wherein according to (i), the one or more compounds comprising Si from which SiO₂ in the zeolitic framework structure is formed comprise a silica gel exhibiting a molar ratio (c H₂O):SiO₂ wherein c is a number in the range of from 0 to 2.5, preferably in the range of from 0 to 2, more preferably in the range of from 0.5 to 1.75, more preferably in the range of from 1.0 to 1.5.
5. The process of any one of embodiments 1 to 4, wherein the zeolitic framework structure of the zeolitic material exhibits framework type CDO.
6. The process of any one of embodiments 1 to 5, wherein c is in the range of from 0.01 to 2.4, preferably in the range of from 0.03 to 2.2, more preferably in the range of from 0.05 to 2.0.
7. The process of any one of embodiments 1 to 6, wherein b is in the range of from 0.01 to 2, preferably in the range of from 0.1 to 2, more preferably in the range of from 0.5 to 2.
8. The process of any one of embodiments 1 to 7, wherein the mixture prepared in (i) comprises one compound comprising Si from which SiO₂ in the zeolitic framework structure is formed, wherein this compound is preferably the silica gel exhibiting a molar ratio (c H₂O):SiO₂, as defined in embodiment 4.
9. The process of any one of embodiments 1 to 8, wherein the mixture prepared in (i) further comprises seed crystals SC comprising, preferably consisting of a crystalline material having a structure of the crystalline material to be prepared.
10. The process of embodiment 9, wherein the mixture prepared in (i) comprises the seed crystals SC in an amount so that mixture exhibits a weight ratio of the seed crystals SC relative to the mixture prepared in (i) in the range of from 0 to 5%, preferably in the range of from 0.1 to 3.5%, more preferably in the range of from 0.2 to 2 weight-%.
11. The process of any one of embodiments 1 to 11, wherein the mixture prepared in (i) further comprises an organotemplate compound OC for the zeolitic material to be prepared.
12. The process of embodiment 11, wherein the mixture prepared in (i) comprises the organotemplate compound OC in an amount so that mixture exhibits a molar ratio (f OC):(a Al₂O₃+SiO₂) wherein f is a number in the range of from 0.05 to 0.3, preferably in the range of from 0.05 to 0.25, more preferably in the range of from 0.05 to 0.2.
13. The process of any embodiment 11 or 12, wherein the organotemplate compound OC comprises, preferably is, diethyldimethylammonium hydroxide.
14. The process of any one of embodiments 1 to 13, wherein at least 99 weight-%, more preferably at least 99.5 weight-%, more preferably at least 99.9 weight-% of the mixture prepared in (i) consist of H₂O, the one or more compounds comprising Si from which SiO₂ in the zeolitic framework structure is formed, optionally the one or more compounds comprising Al from which Al₂O₃ in the zeolitic framework structure is formed, preferably the seed crystals SC and preferably the organotemplate compound OC.
15. The process of any one of embodiments 1 to 14, wherein preparing the mixture in (i) comprises grinding.
16. The process of embodiment 15, wherein the grinding is carried out for a time in the range of from 0.1 to 30 min, preferably in the range of from 0.5 to 20 min, more preferably in the range of from 1 to 15 min.
17. The process of embodiment 15 or 16, wherein the grinding is carried out at a temperature of the mixture in the range of from 10 to 50° C., preferably in the range of from 15 to 40° C., more preferably in the range of from 20 to 30° C.
18. The process of any one of embodiments 1 to 17, wherein subjecting the mixture obtained in (i) to crystallization according to (ii) is carried out in a pressure-tight vessel, preferably in an autoclave, preferably under autogenous pressure.
19. The process of any one of embodiments 1 to 18, wherein subjecting the mixture obtained in (i) to crystallization according to (ii) comprises stirring the mixture.
20. The process of any one of embodiments 1 to 19, wherein subjecting the mixture obtained in (i) to crystallization comprises heating the mixture to the crystallization temperature at a heating rate in the range of from 1 to 20 K/min, preferably in the range of from 1 to 10 K/min, more preferably in the range of from 1 to 5 K/min.
21. The process of any one of embodiments 1 to 20, wherein the crystallization temperature according to (ii) is in the range of from 170 to 350° C., preferably in the range of from 175 to 300° C., more preferably in the range of from 180 to 250° C., more preferably in the range of from 180 to 240° C.
22. The process of any one of embodiments 1 to 20, wherein the crystallization temperature according to (ii) is in the range of from 190 to 240° C., preferably in the range of from 190 to 220° C., more preferably in the range of from 190 to 210° C., more preferably in the range of from 195 to 205° C.
22. The process of any one of embodiments 1 to 21, wherein the crystallization time according to (ii) is in the range of from 12 to 48 h, preferably in the range of from 18 to 42 h, more preferably in the range of from 24 to 36 h.
23. The process of any one of embodiments 1 to 21, wherein the crystallization time according to (ii) is in the range of from 0.5 to 36 h, more preferably in the range of from 1 to 36 h, more preferably in the range of from 6 to 36 h, more preferably in the range of from 12 to 36 h, more preferably in the range of from 24 to 36 h.
24. The process of any one of embodiments 1 to 23, wherein the space-time yield of the crystallization according to (ii) is in the range of from 100 to 150,000 kg/m³/d, wherein the space-time yield is defined as the mass/kg of the crystalline precursor obtained from (ii) divided by the volume/m³ of the mixture prepared in (i) divided by the crystallization time/d according to (ii).
25. The process of any one of embodiments 1 to 24, wherein the space-time yield of the crystallization according to (ii) is in the range of from 100 to 10,000 kg/m³/d, preferably in the range of from 100 to 1,000 kg/m³/d, more preferably in the range of from 150 to 250 m³/d.
26. The process of any one of embodiments 1 to 25, wherein after crystallization according to (ii), the crystalline precursor thereof is subjected to ion exchange.
27. The process of any one of embodiments 1 to 27, wherein the crystalline precursor obtained in (ii) is calcined.
28. The process of embodiment 27, wherein the crystalline precursor obtained in (ii) is calcined in a gas stream having a temperature in the range of from 400 to 600° C., preferably in the range of from 450 to 550° C.
29. The process of embodiment 28, wherein the gas stream is one or more of oxygen, nitrogen, air, and lean air.
30. The process of any one of embodiments 27 to 29, wherein the crystalline precursor obtained in (ii) is calcined for a calcination time in the range of from 0.5 to 12 h, preferably in the range of from 1 to 9 h, more preferably in the range of from 2 to 6 h.
31. The process of any one of embodiments 27 to 30, wherein after calcination, the calcined material is subjected to ion exchange.
32. A crystalline precursor of a zeolitic material having a zeolitic framework structure which exhibits a molar ratio (a Al₂O₃):SiO₂, obtainable or obtained by a process according to any one of embodiments 1 to 31, wherein a is a number in the range of from 0 to 0.5.
33. A crystalline precursor of zeolitic material having a zeolitic framework structure which exhibits a molar ratio (a Al₂O₃):SiO₂, wherein the precursor has RUB-36 structure, wherein a is a number in the range of from 0 to 0.5, wherein said precursor exhibits a Q4:Q3 ratio determined according to ³¹Si NMR as described in Reference Example 1 herein, wherein Q4:Q3 is at least 72.0:28:0.
34. The crystalline precursor of embodiment 33, wherein the Q4:Q3 ratio is at least 73.0:27:0, preferably at least 74.0:26.0, more preferably at least 74.5:25.0.
35. The crystalline precursor of embodiment 33, wherein the Q4:Q3 ratio is in the range of from 73.0:27.0 to 80.0:20:0, preferably in the range of from 74.0:26.0 to 79.0:21:0, more preferably in the range of from 74.5:25.0 to 78.0:22:0.
36. The crystalline precursor of any one of embodiments 33 or 35, wherein a is 0.
37. Use of a crystalline precursor according to any one of embodiments 32 to 36 as an absorbent, an adsorbent, an ion exchanger, an absorbent, a catalyst or a precursor thereof, a catalyst component or a precursor thereof, a catalyst support or a precursor thereof.

The present invention is further illustrated by the following reference examples, comparative examples, and examples.

### EXAMPLES

### Reference Example 1: ²⁹Si NMR Spectra

For the determination of the silanol concentration, the ²⁹Si MAS NMR experiments were carried out at room temperature on a VARIAN Infinity Plus-400 spectrometer using 7.0 mm ZrO₂ rotors. The ²⁹Si MAS NMR spectra were collected at 79.5 MHz using a 4.0 μs π/4 (microsecond pi/4) pulse with 60 s recycle delay and 4000 scans. All ²⁹Si spectra were recorded on samples spun at 4 kHz, and chemical shifts were referenced to 4,4-dimethyl-4-silapentane sulfonate sodium (DSS). For the determination of the silanol group concentration, a given ²⁹Si MAS NMR spectrum is deconvolved by the proper Gaussian-Lorentzian line shapes. The concentration of the silanol groups with respect to the total number of Si atoms is obtained by integrating the deconvolved ²⁹Si MAS NMR spectra.

All ²⁹Si solid-state NMR experiments were performed using a VARIAN Infinity Plus-400 spectrometer with 300 MHz ¹H Larmor frequency (Varian, America). Samples were packed in 7 mm ZrO₂ rotors, and measured under 5 kHz Magic Angle Spinning at room temperature. ²⁹Si direct polarization spectra were obtained using (pi/2)-pulse excitation with 5 microsecond pulse width, a ²⁹Si carrier frequency corresponding to −65 ppm in the spectrum, and a scan recycle delay of 120 s. Signal was acquired for 25 ms under 45 kHz high-power proton decoupling, and accumulated over 10 to 17 hours. Spectra were processed using Bruker Topspin with 30 Hz exponential line broadening, manual phasing, and manual baseline correction over the full spectrum width. Spectra were referenced with the polymer Q8M8 as an external secondary standard, setting the resonance of the trimethylsilyl M group to 12.5 ppm. The spectra were then fitted with a set of Gaussian line shapes, according to the number of discernable resonances. Fitting was performed using DMFit (Massiot et al., Magnetic Resonance in Chemistry, 40 (2002) pp 70-76). Peaks were manually set at the visible peak maxima or shoulder. Both peak position and line width were then left unrestrained, i.e., fit peaks were not fixed at a certain position. The fitting outcome was numerically stable, i.e., distortions in the initial fit setup as described above did lead to similar results. The fitted peak areas were further used normalized as done by DM Fit. For the quantification of spectrum changes, a ratio was calculated that reflects changes in the peak areas “left hand” and “right hand”.

### Reference Example 2: XRD Spectra

X-ray powder diffraction (XRD) patterns were measured with a Rigaku Ultimate VI X-ray diffractometer (40 kV, 40 mA) using Cu(K alpha) (lambda=1.5406 Angstrom) radiation.

### Reference Example 3: ¹³C NMR Spectra

¹³C solid MAS NMR spectra were recorded on a Varian Infinity Plus 400 spectrometer. ¹³C liquid NMR spectra were recorded on a Bruker Avance 500 spectrometer using a 5 mm QNP probe equipped with z-gradient coil.

### Reference Example 4: SEM

Scanning electron microscopy (SEM) experiments were performed on Hitachi SU-1510 electron microscopes.

### Reference Example 5: Nitrogen Sorption

The nitrogen sorption isotherms at the temperature of nitrogen liquid were measured using Micromeritics ASAP 2020M and Tristar system.

### Reference Example 6: Sample Composition

The sample composition was determined by inductively coupled plasma (ICP) with a Perkin-Elmer 8000 emission spectrometer.

### Reference Example 7: Thermogravimetry

The thermogravimetry-differential thermal analysis (TG-DTA) experiments were carried out on a Perkin-Elmer TGA 7 unit in air at heating rate of 10° C./min in the temperature range from room temperature to 1000° C.

### Reference Example 8: Solid Silica Gel

The solid silica gel from Qingdao Haiyang Chemical Reagent Co, Ltd., had a pore volume of 0.9-1.0 cm³/g (BET (3H-2000PS2) made by Beishide Instrument Technology (Beijing) Co., Ltd), a pore size of 10 nm (BET), a particle size (percentage of particles for passing the sieve with 200 mesh) of >90%, a silica content of >98% (dissolved by HF, and chemical analysis), and a bulk density of 380-480 g/L (tapped and full filling 100 mL measuring cylinder).

### Comparative Example 1: Hydrothermal Synthesis of RUB-36

1.2 g of SiO₂ (fumed silica; essentially no water contained) and 5.174 g of dimethyldiethylammonium hydroxide (DMDEAOH, 20 weight-% in water) were added together (1.00 SiO₂:0.43 DMDEAOH:11.50 H₂O) and stirred for 4 h, then transferred into an autoclave and crystallized at 140° C. for 14 d (oven: DGG-9070GD from ENXIN; the crystallization temperature referred to above is the oven temperature). The isolated yield of crystalline material of structure RUB-36 was 67.8%.

The BET specific surface area of the calcined product according to DIN 66131 (nitrogen absorption) was 288 m²/g. Furthermore, the calcined product had a micropore volume of 0.13 m³/g, determined according to DIN 66135.

FIG. 1 shows the XRD pattern of the non-calcined product, from which it is apparent that said product has a RUB-36 framework structure.

Comparative Example 1 was repeated but at different crystallization temperatures and crystallization times. Only amorphous material could be isolated after (a) 9 d at 160° C. (b) 3 d at 180° C. and (c) 12 d at 200° C. which shows that at higher temperatures and shorter times, the hydrothermal synthesis route is not possible.

### Comparative Example 2: Hydrothermal Synthesis of a Zeolitic Material Having Framework Type MFI

Zeolite having a framework type MFI was synthesized under hydrothermal conditions according to Wang et al. in Chem. Commun., 2010, 46, 7418. As a typical run, 14 g of TEOS and 22 g of TPAOH (20 wt. %, diluted from TPAOH of 40 wt. %) were added into 22 g of distilled water, after fully dissolved, 0.093 g of aluminium isopropoxide was added. After stirring for 24-48 h, the gel was transferred into an autoclave and heated at 180° C. for 48 h. The organic templates were removed after calcination at 550° C. for 5 h.

### Example 1: Solidothermal Synthesis of RUB-36

a) 1.2 g SiO₂ solid silica gel according to Reference Example 8 (Qingdao Haiyang Chemical Reagent Co, Ltd.), 0.75 g dimethyldiethylammonium hydroxide (DMDEAOH, 50 weight-% in water) and 0.0254 g RUB-36 seed crystals (synthesized as described in Comparative Example 1 above;) were added into a mortar one by one and mixed together. After grinding for 5 minutes, the powder with molar composition of 1 SiO₂:0.15 DMDEAOH:1.02 H₂O was transferred to an autoclave and sealed. The solid mixture was crystallized at 200° C. for 1.5 days.
   The total yield was 82% based on the total raw materials (water excluded), and the yield with respect to SiO₂ was 99.9%. The space-time-yield was 178 kg/m³/day. The space-time-yield reported in the literature (Gies et al.) was 5 kg/m³/day.
   The crystallized product RUB-36 was converted into H-form by calcination at 500° C. for 5 h. The BET specific surface area of the calcined product according to DIN 66131 is 281 m²/g. The material obtained had a micropore volume, determined according to DIN 66135, of 0.12 m³/g. FIG. 2 shows the SEM image of the non-calcined material obtained in Example 1 exhibiting the platelet morphology typical for layered zeolites. The XRD pattern is displayed in FIG. 4, pattern (d).
b) The experiment was repeated, but at different crystallization temperatures.
   FIG. 3 shows the ²⁹Si NMR spectra of (a) RUB-36 prepared as described in Comparative Example 1 (Q3:Q4=28.3:71.7), (b) RUB-36 prepared as described in Example 1 a) at 140° C. for 20 d (Q3:Q4=26.0:74.0), (c) RUB-36 prepared as described in Example 1 a) at 180° C. for 3 d (Q3:Q4=25.4:74.6). These materials exhibit peaks at −106, −112, and −115 ppm, which are reasonably assigned to Q³ [Si(SiO)₃OH, −106 ppm] and Q⁴ [Si(SiO)₄, −112, and −115 ppm] silica species, respectively (see Fyfe et al.). It is noted that the Q⁴/Q³ ratio (74.6/25.4) of the inventive RUB-36 material according to (c) is higher than that (71.7/28.3) of the comparative material according to (a), indicating that the inventive RUB-36 materials a have higher silica condensation degree, which is very favorable for enhancement of thermal and hydrothermal stabilities of porous materials (Jomekian et al.).
   FIG. 4 shows XRD patterns of RUB-36 synthesized for (a) 20 d at 140° C., (b) 9 d at 160° C., (c) 3 d at 180° C., and (d) 1.5 d at 200° C. It can be seen from the XRD patterns that the crystallinity is apparently unaffected by applying higher crystallization temperatures.
c) Example 1 a) was repeated at 180° C., 3 d but with different H₂O/SiO₂ molar ratios (a) 1.02 (b) 1.97 (c) 2.78 (c) 3.89 while keeping the DMDEA/SiO₂ ratio at 0.15. Condition (a) resulted in phase pure RUB-36, (b) resulted in RUB-36 together with amorphous material, (c) resulted in amorphous material together with RUB-36 and (d) resulted solely amorphous material.
   Repeating Example 1 a) while further increasing the H₂O/SiO₂ molar ratio to 11.4 together with raising the DMDEA/SiO₂ ratio to 0.43 (e), as well as a adjusting H₂O:SiO₂ molar ratio to 7.86 together with a DMDEA/SiO₂ ratio of 0.97 (f), resulted in only amorphous materials for both conditions (e) and (f).
   FIG. 5 shows the ¹³C NMR of (a) organic template as is, (b) template after 3 days at 180° C. for RUB-36 prepared according to Example 1, and (c) template after 3 days at 180° C. for RUB-36 prepared according to Comparative Example 1.
   It is shown that higher amounts of water present in the synthesis mixture typically for hydrothermal crystallization conditions led to decomposition of the organic template at elevated temperatures

### Example 2: Solidothermal Synthesis of a Zeolitic Material Having Framework Type BEA

1.29 g SiO₂ solid silica gel according to Reference Example 8 (Qingdao Haiyang Chemical Reagent Co, Ltd.), 1.38 g of Na₂SiO₃×9H₂O (analytical grade, SiO₂ of 20 weight-%, Aladdin Chemistry Co., Ltd.), 0.108 g Boehmite (70 weight-% Al₂O₃, Liaoning Hydratight Science and Technology Development Co., LTD) and 0.06 g Beta seeds (Si/Al=12.5; XRD pattern shown in FIG. 11) were added into a mortar one by one and mixed together. After grinding for 5 minutes, the powder with molar composition of 0.18 Na₂O:1 SiO₂:0.03 Al₂O₃:1.73 H₂O was transferred to an autoclave and sealed. The solid mixture was crystallized at (a) 6 d at 120° C., (b) 3 d at 140° C., (c) 1 d at 160° C., (d) 6 h at 180° C., and (e) 2 h at 200° C.

The yield for the inventive experiment (e) with respect to SiO₂ was 95%. The space-time-yield was 2,523 kg/m³/day. The space-time yield reported in literature (Fan et al.) was 160 kg/m³/day.

The BET specific surface area of the ion exchanged and calcined product (e) according to DIN 66131 was 436 m²/g. Furthermore, the product had a micropore volume of 0.20 m³/g determined according to DIN 66135.

FIG. 6 shows the XRD pattern of the zeolitic product, crystallized (a) 6 d at 120° C., (b) 3 d at 140° C., (c) 1 d at 160° C., (d) 6 h at 180° C., and (e) 2 h at 200° C. from which it is apparent that the product has a BEA framework structure.

### Example 3: Solidothermal Synthesis of a Zeolitic Material Having Framework Type MOR

SiO₂×2 H₂O was prepared by impregnating (water was added into the silica gel drop by drop, and the impregnated material was used directly) solid silica gel according to Reference Example 8 (Qingdao Haiyang Chemical Reagent Co, Ltd.) with demineralized water. 1.332 g of this SiO₂×2H₂O, 0.181 g of NaAlO₂ (Sinopharm Chemical Reagent Co., Ltd.), 0.068 g NaOH (analytical grade, 96%, Sinopharm Chemical Reagent Co., Ltd.) and 0.03 g MOR seeds (prepared by crystallizing a synthesis gel with the composition of 0.16 Na₂O:1 SiO₂:0.07 Al₂O₃:2.14 H₂O at 180° C. for 48 h; the XRD pattern so shown in FIG. 12) were added into a mortar one by one and mixed together. After grinding for 5 minutes, the powder with molar composition of 0.22 Na₂O:1 SiO₂:0.07 Al₂O₃:2.09 H₂O was transferred to an autoclave and sealed. The solid mixture was crystallized at 240° C. for 1.5 h.

The yield with respect to SiO₂ was 99.9%. The space-time-yield was 4,609 kg/m³/day. The space-time yield reported in literature (Ren et al.) was 67 kg/m³/day.

The obtained powder was subdued to triple ion-exchange with 1 M NH₄NO₃ solution at 80° C. for 2 h, followed by calcination at 550° C. for 4 h.

The BET specific surface area of the product in its H-form according to DIN 66131 was 383 m²/g. The Langmuir Surface Area according to DIN 66131 was 502 m²/g. Furthermore, the product had a micropore volume of 0.18 m³/g, determined according to DIN 66135.

FIG. 7 shows the XRD pattern of the zeolitic product from which it is apparent that the product has a MOR framework structure.

### Example 4: Solidothermal Synthesis of a Zeolitic Material Having Framework Type MFI

### Example 4a

0.262 g of solid silica gel according to Reference Example 8 (Qingdao Haiyang Chemical Reagent Co, Ltd.), 1.422 g of Na₂SiO₃×9H₂O (analytical grade, SiO₂ of 20 weight-%, Aladdin Chemistry Co., Ltd.), 0.24 g TPABr (tetrapropylammonium bromide, analytical grade, 98%, Aladdin Chemistry Co., Ltd.) 0.46 g NH₄Cl and 0.03 g MFI seeds (pure silica; the XRD pattern is shown in FIG. 13) were added into a mortar one by one and mixed together. After grinding for 5 minutes, the powder with molar composition of 0.53 Na₂O:1 SiO₂:0.1 TPABr:4.81 H₂O was transferred to an autoclave and sealed. The solid mixture was crystallized at 240° C. for 0.5 h.

The total yield was 96.7% based on the total raw materials (water excluded), and the yield with respect to SiO₂ was 99.9%. The space-time yield was 12,800 kg/m³/day. The space-time yield reported in literature (Hsu et al.) was 530 kg/m³/day.

The obtained powder was subjected to calcination at 550° C. for 5 h in order to remove the template followed by triple ion-exchange with 1 M NH₄NO₃ solution at 80° C. for 2 h, followed by calcination at 500° C. for 5 h. The yield based on SiO₂ was 94.9% and the space-time yield was 11,028 kg/m³/day.

The BET specific surface area of the product in its H-form according to DIN 66131 was 408 m²/g. The Langmuir surface area according to DIN 66131 was 562 m²/g. Furthermore, the product had a micropore volume of 0.18 cm³/g, determined according to DIN 66135.

FIG. 8a shows the XRD pattern of the zeolitic product from which it is apparent that the product has a MFI framework structure.

### Example 4b

1.2 g of solid silica gel (Qingdao Haiyang Chemical Reagent Co, Ltd.), 0.293 g of NaOH (analytical grade, 96%, Sinopharm Chemical Reagent Co., Ltd.) and 0.625 g tetraethylammonium hydroxide (TEAOH; 35% in water, TCl) were added into a mortar one by one and mixed together. After grinding for 5 min, the powder with molar composition of 0.183 Na₂O:1 SiO₂:0.074 TEAOH:1.13 H₂O was transferred to an autoclave and sealed. The solid mixture was crystallized at 200° C. for 3 h.

The yield with respect to SiO₂ was 96.7%. The space-time yield was 2,792 kg/m³/day. The template was removed via calcination.

FIG. 8b shows the XRD pattern of the zeolitic product from which it is apparent that the product has a MFI framework structure.

### Example 4c

0.008 g of boehmite (Al₂O₃ of 70 wt. %, Liaoning Hydratight Co) was added into 1.0 g of Tetrapropylammonium hydroxide (TPAOH, 40 wt. %, Shanghai Aladdin Bio-Chem Technology Co., LTD), after fully dissolved, the mixture was fully grinded with 1.0 g of fumed silica (Shanghai Tengmin Industrial Co). Then, the powder mixture was transferred into an autoclave and sealed. After heating at 140° C. for 300 min (or alternatively at 180° C. for 180 min, or at 200° C. for 72 min), the sample was fully crystallized.

The H-form was then obtained by calcination at 550° C. for 5 h.

The yield with respect to SiO₂ was more than 97%.

The BET specific surface area of the product in its H-form according to DIN 66131 was 434 m²/g. Furthermore, the product had a micropore volume of 0.182 cm³/g, determined according to DIN 66135.

FIG. 8c shows the XRD pattern of the zeolitic product obtained from which it is apparent that the product has a MFI framework structure.

### Example 5: Solidothermal Synthesis of a Zeolitic Material Having Framework Type CHA

1.026 g of solid silica gel according to Reference Example 8 (Qingdao Haiyang Chemical Reagent Co, Ltd.), 1.059 g of Na₂SiO₃×9H₂O (analytical grade, SiO₂ of 20 weight-%, Aladdin Chemistry Co., Ltd.), 0.456 g of Al₂(SO₄)₃×18 H₂O (analytical grade, 99%, Sinopharm Chemical Reagent Co., Ltd.), 0.6 g N,N,N-trimethyladamantylammonium hydroxide (65% in H₂O, BASF) and 0.025 g CHA seeds (seed crystals were synthesized by conventional hydrothermal crystallization for 7 days at 160° C. employing a synthesis gel of the following composition: 0.12 Na₂O:1 SiO₂:0.03 Al₂O₃:20.0 H₂O; the XRD pattern is shown in FIG. 14) were added into a mortar one by one and mixed together. After grinding for 5 minutes, the powder with molar composition of 0.18 Na₂O:1 SiO₂:0.03 Al₂O₃:0.09 N,N,N-trimethyladamantylammonium hydroxide:2.76 H₂O was transferred to an autoclave and sealed. The solid mixture was crystallized at 240° C. for 1.5 h.

The yield with respect to SiO₂ was 99.2%. The space-time-yield was 4,738 kg/m³/day.

The crystallized product Na-CHA was converted into H-form by triple ion-exchange with 1 M NH₄NO₃ solution at 80° C. for 2 h, followed by calcination at 500° C. for 5 h.

FIG. 9 shows the XRD pattern of the zeolitic product obtained from which it is apparent that the product in its Na-form as well after ion exchange as H-form has a CHA framework structure/

The experiment was repeated but at different crystallization temperatures. FIG. 10 shows the XRD pattern of the zeolitic product obtained from (a) 5 d at 160° C., (b) 2 d at 180° C., (c) 12 h at 200° C., (d) 5 h at 220° C. and (e) 1.5 h at 240° C. from which it is apparent that the product has a CHA framework structure.

### Example 6: Investigating the Effect of H₂O/Si Ratio

The effect of varying the H₂O/Si ratio in the overall raw mixture employed based on the protocol of Example 4c was investigated, wherein the heating step in the sealed autoclave was carried out at 180° C. for 24 h.

FIG. 16 shows the SEM images of zeolites having framework type MFI synthesized with different ratios of H₂O/Si of the raw mixtures. Clearly, with increase of water amount, the sizes of crystals are increasing. For instance, a sample based on example 4c wherein the overall H₂O/Si ratio in the raw materials used was 1:1 gave a crystal size at about 100-200 nm. However, when the H₂O/Si ratios are increased to 3:1, 5:1, and 9:1, the sizes of obtained samples are increased to 500 nm, 3 μm, and 5 μm respectively. Accordingly, our results show that employing less water is helpful to decrease the zeolite crystal size within a certain scale of H₂O/Si ratio. Apparently, the increase of water amount leads to the decrease of nucleation concentration, which is of great significance for the formation of smaller zeolite crystal size, as the lower nucleus concentration means the relatively lower speed of nucleation and higher speed of nucleus growth.

### Example 7: Methanol-to-Olefins (MTO) Reaction with Zeolitic Material Having Framework Type MFI

The MTO reaction was carried out with a fixed-bed tubular steel reactor with an inner diameter of 8 mm and a length of 30 cm at atmospheric pressure. After 0.50 g of catalyst (20-40 mesh) from example 4c (according to the invention) or from comparative example 2, was loaded in the middle of tubular steel between two layers of quartz wool, it was pretreated in flowing nitrogen at 500° C. for 2 h and cooled down to the reaction temperature of 480° C. The methanol was injected into the catalyst bed by a pump with weight hourly space velocity (WHSV) of 1.0 h⁻¹. The products from the reactor were analyzed on-line by an Agilent 6890N gas chromatograph equipped with an FID detector and a PLOT-Al₂O₃ capillary column (50 m×0.53 mm×25 μm). Selectivity to the products of interest was expressed as mass percentage of each product among all the detectable products except dimethyl ether.

FIG. 15 shows dependences of catalytic conversion of methanol and product selectivities on the reaction time with the Example 4c zeolite and Comparative Example 2 zeolite. Clearly, at early stage of catalytic reaction, the two catalysts are both very active, giving full conversion of methanol. For example, at reaction time of 1.0 h, the major products include alkanes (C₁-C₅), light olefins (ethylene, propylene, and butane), and aromatics. Notably, both of the two catalysts give very high propylene selectivity, while Example 4c gives 54.0%, which is even higher than the Comparative Example 2 at 52.9%. The total olefin (ethylene, propylene and butylene) selectivity of Example 4c and Comparative Example 2 are 81.9% and 82.1%, respectively, which are comparable. However, Example 4c gives lower ethylene selectivity at 9.6% and higher butylene selectivity at 18.3% respectively, whereas Comparative Example 2 catalyst gives 12.7% and 16.7% respectively. This phenomenon means Example 4c possesses higher selectivity for larger-sized olefins, ie, propylene and butylene, than the Comparative Example 2 catalyst, which may indicate the advantage of Example 4c at mass transfer during the catalytic reaction. Regarding the low value-added methane, Example 4c gives selectivity at 1.95% and Comparative Example 2 gives selectivity at 3.28%. Furthermore, compared to the Comparative Example 2 catalyst, the Example 4c catalyst exhibits remarkably prolonged catalyst lifetime. Notably, the lifetime of Example 4c was nearly three times longer than Comparative Example 2. The TG-DTA curves of the two deactivated catalysts show that Example 4c has the slower rate of coke deposition.

These results show that Example 4c which was synthesized in 3 h under solvent-free conditions has improved catalytic properties in the methanol-to-olefins reaction than the conventional hydrothermal synthesized ones.

### SHORT DESCRIPTION OF THE FIGURES

FIG. 1 shows the XRD pattern of the un-calcined zeolitic product obtained in Reference Example 1. In the figure, the diffraction angle 2 theta in ° is shown along the abscissa and the intensities are plotted along the ordinate.

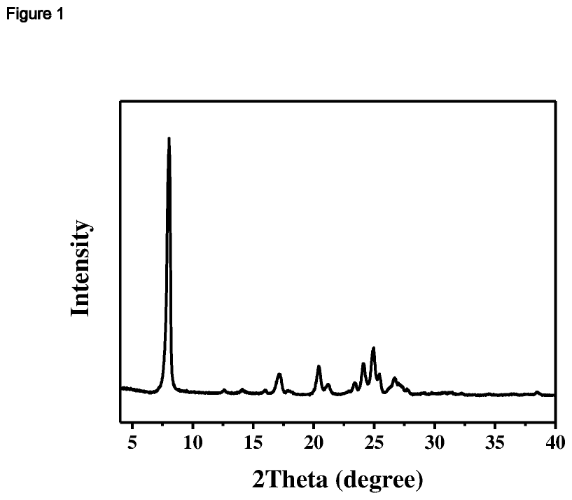

FIG. 2 shows the SEM image of the un-calcined zeolitic product obtained in Example 1 exhibiting the platelet morphology typical for layered zeolites

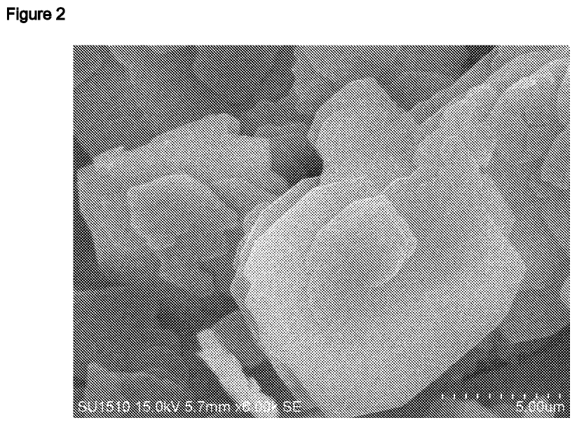

FIG. 3 shows the ²⁹Si NMR spectra of—from top to bottom—(a) RUB-36 prepared according to Comparative Example 1 at 140° C. (Q3:Q4=28.3:71.7), (b) RUB-36 prepared according to Example 1 at 140° C. (Q3:Q4=26.0:74.0), (c) RUB-36 prepared according to Example 1 at 180° C. (Q3:Q4=25.4:74.6).

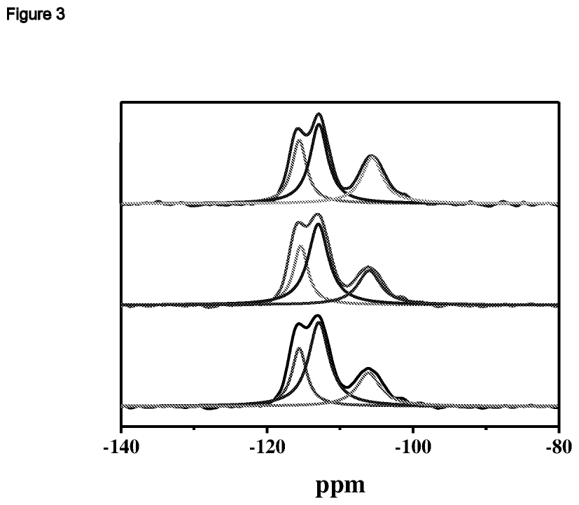

FIG. 4 shows XRD patterns of RUB-36 prepared according to Example 1—from bottom to top—synthesized for (a) 20 d at 140° C., (b) 9 d at 160° C., (c) 3 d at 180° C., and (d) 1.5 d at 200° C. In the figure, the diffraction angle 2 theta in ° is shown along the abscissa and the intensities are plotted along the ordinate.

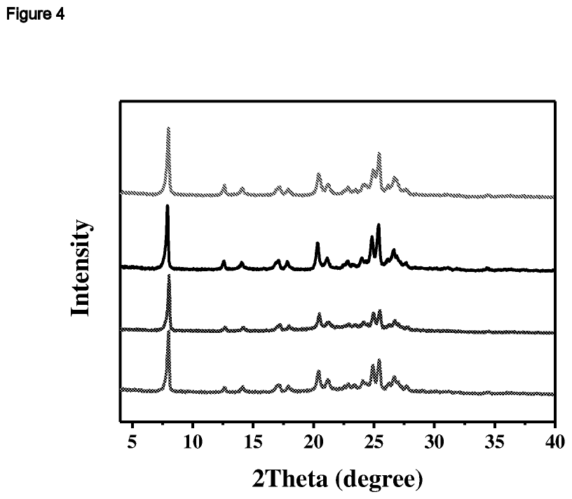

FIG. 5 shows the ¹³C NMR of (a) organic template as is, (b) template after 3 days at 180° C. for RUB-36 prepared according to Example 1, and (c) template after 3 days at 180° C. for RUB-36 prepared according to Comparative Example 1.

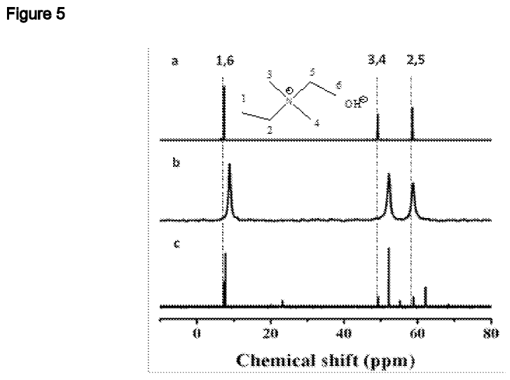

FIG. 6 shows the XRD pattern of the zeolitic products (BEA) from Example 2—from bottom to top —, crystallized (a) 6 d at 120° C., (b) 3 d at 140° C., (c) 1 d at 160° C., (d) 6 h at 180° C., and (e) 2 h at 200° C. In the figure, the diffraction angle 2 theta in ° is shown along the abscissa and the intensities are plotted along the ordinate.

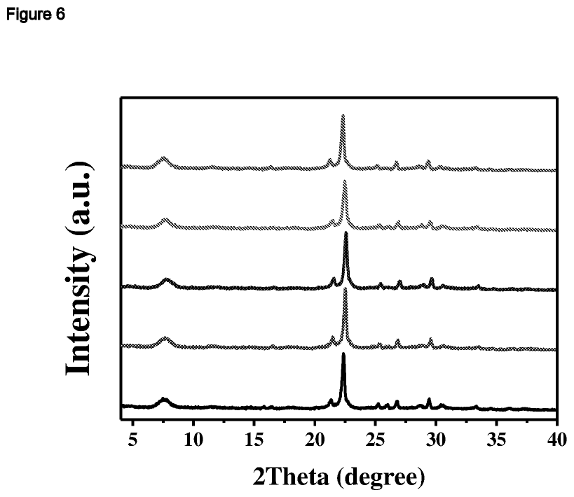

FIG. 7 shows the XRD pattern of the zeolitic product obtained in Example 3 from which it is apparent that the product has a MOR framework structure. In the figure, the diffraction angle 2 theta in ° is shown along the abscissa and the intensities are plotted along the ordinate.

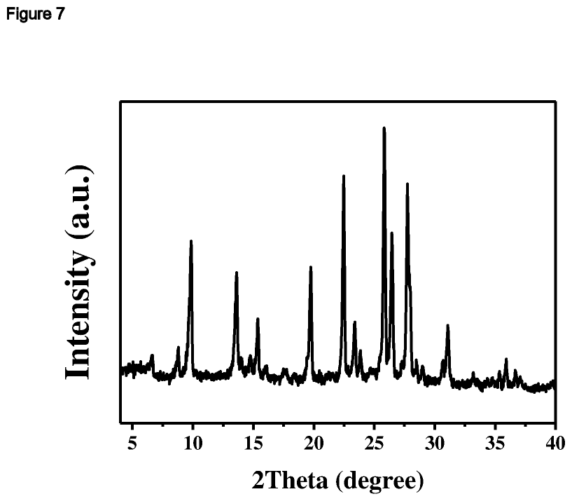

FIG. 8a shows the XRD pattern of the zeolitic product obtained in Example 4a from which it is apparent that the product has a MFI framework structure. In the figure, the diffraction angle 2 theta in ° is shown along the abscissa and the intensities are plotted along the ordinate.

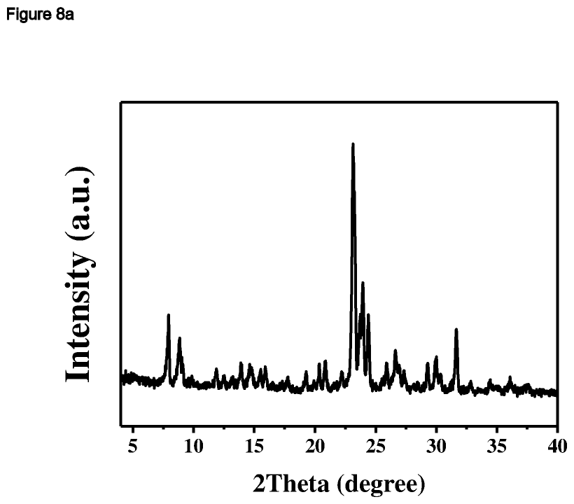

FIG. 8b shows the XRD pattern of the zeolitic product obtained in Example 4b from which it is apparent that the product has a MFI framework structure. In the figure, the diffraction angle 2 theta in ° is shown along the abscissa and the intensities are plotted along the ordinate.

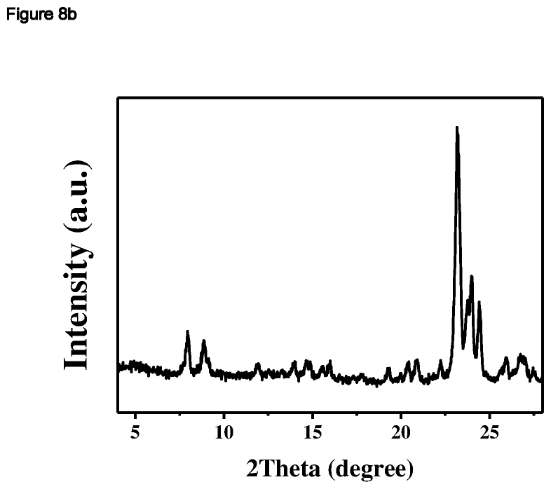

FIG. 8c: shows the XRD pattern of the zeolitic product obtained in Example 4c from which it is apparent that the product has a MFI framework structure. In the figure, the diffraction angle 2 theta in ° is shown along the abscissa and the intensities are plotted along the ordinate.

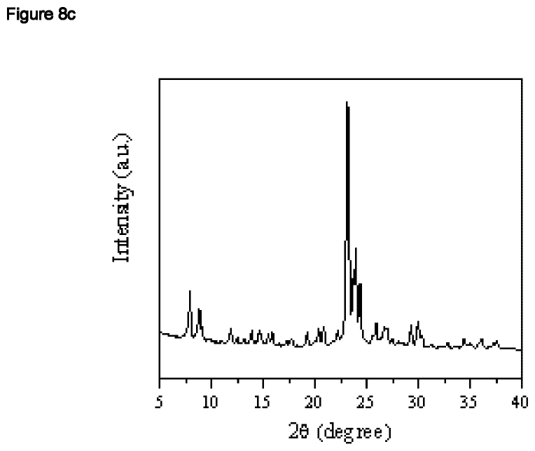

FIG. 9 shows the XRD pattern of the zeolitic product obtained from Example 5 from which it is apparent that the product in its Na-form as well after ion exchange as H-form has a CHA framework structure. In the figure, the diffraction angle 2 theta in ° is shown along the abscissa and the intensities are plotted along the ordinate.

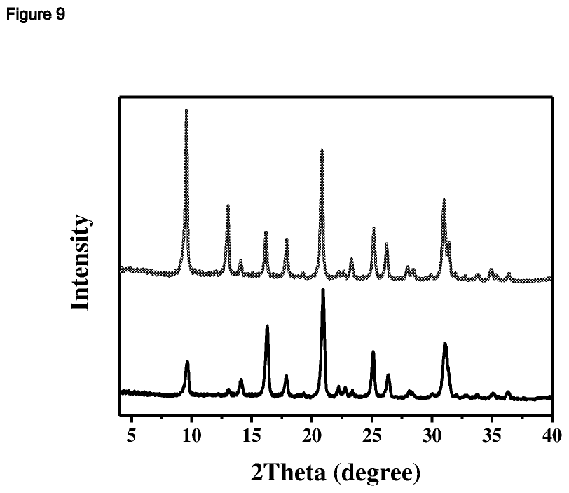

FIG. 10 shows the XRD pattern of the zeolitic products obtained from Example 5 prepared using different crystallization conditions. In the figure, the diffraction angle 2 theta in ° is shown along the abscissa and the intensities are plotted along the ordinate.

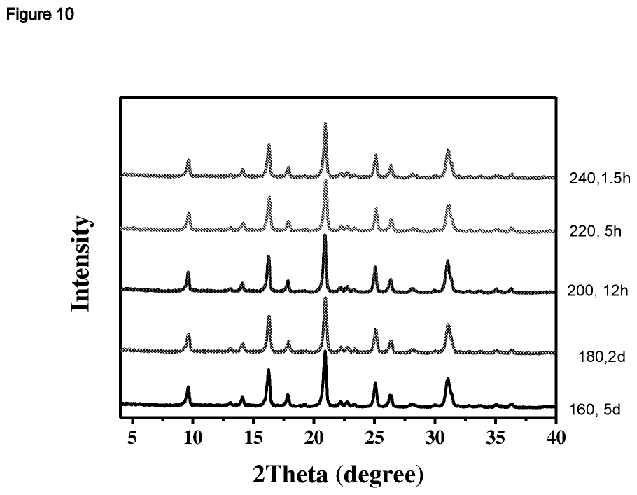

FIG. 11 shows the XRD pattern of the seed crystal material (BEA) used in Example 2. In the figure, the diffraction angle 2 theta in ° is shown along the abscissa and the intensities are plotted along the ordinate.

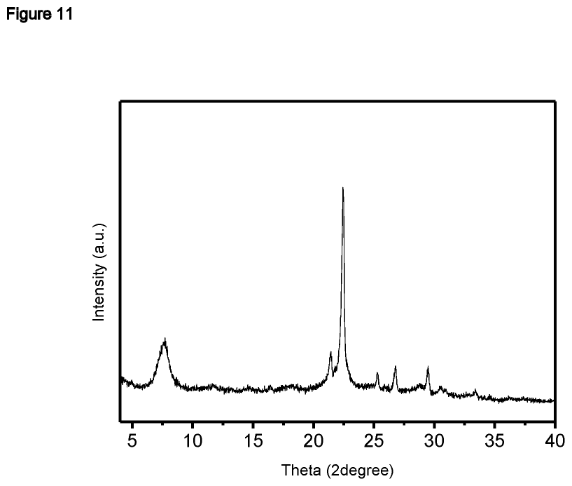

FIG. 12 shows the XRD pattern of the seed crystal material (MOR) used in Example 3. In the figure, the diffraction angle 2 theta in ° is shown along the abscissa and the intensities are plotted along the ordinate.

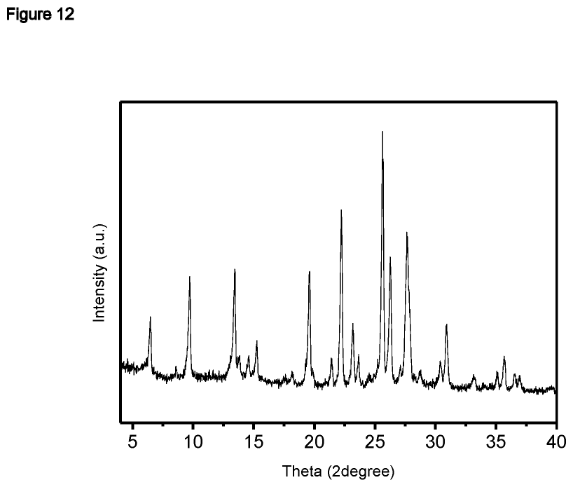

FIG. 13 shows the XRD pattern of the seed crystal material (MFI) used in Example 4. In the figure, the diffraction angle 2 theta in ° is shown along the abscissa and the intensities are plotted along the ordinate.

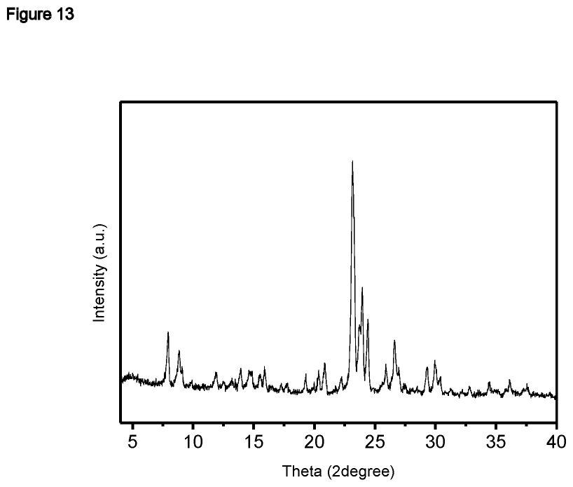

FIG. 14 shows the XRD pattern of the seed crystal material (CHA) used in Example 5. In the figure, the diffraction angle 2 theta in ° is shown along the abscissa and the intensities are plotted along the ordinate.

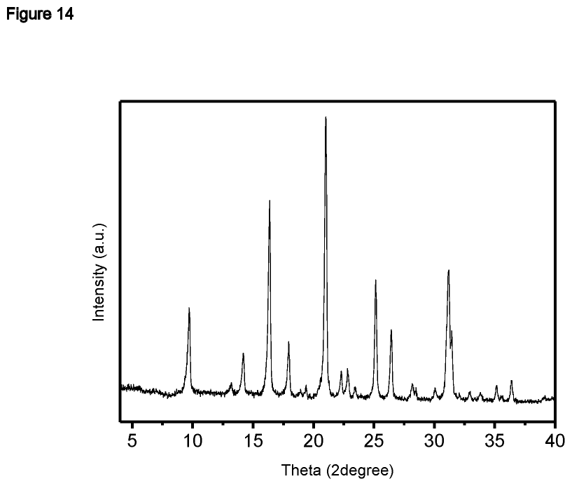

FIG. 15 shows dependences of catalytic conversion of methanol and product selectivities on the reaction time over the example 4c and comparative example 2 zeolites.

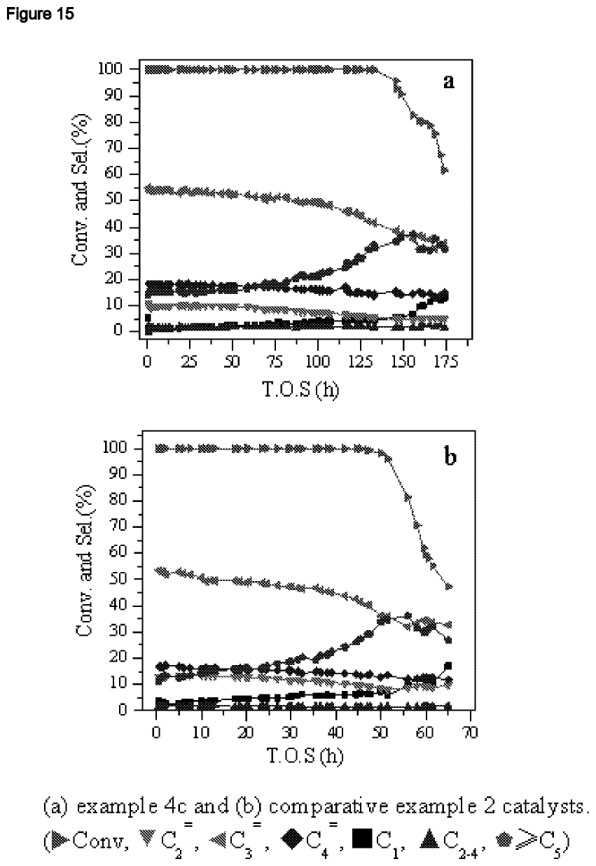

FIG. 16 shows the SEM images of zeolites having framework type MFI synthesized with different ratios of H₂O/Si of example 6.

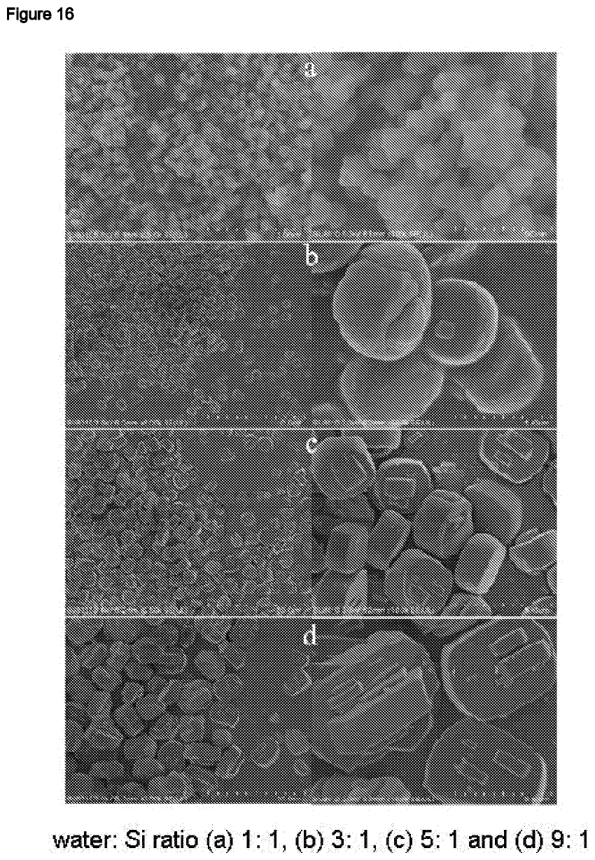

### CITED LITERATURE

WO 2016/058541 A1
H. Gies, U. Müller, B. Yilmaz, M. Feyen, T. Tatsumi, H. Imai, H. Zhang, B. Xie, F. S. Xiao, X. Bao, W. Zhang, T. De Baerdemaker, D. De Vos, Chem. Mater. 2012, 24, pp. 2536
W. Fan, C.-C. Chang, P. Domath, Z. Wang, U.S. Pat. No. 9,108,190 B1, 2015
L. Ren, Q. Guo, H. Zhang, L. Zhu, C. Yang, L. Wang, X. Meng, Z. Feng, C. Li, F.-S. Xiao, J. Mater. Chem., 2012, 22, pp. 6564
C.-Y. Hsu, A. S. T Chiang, R. Selvin, R. W. Thompson, J. Phys. Chem. B., 2005, 109, pp. 18813
C. A. Fyfe, D. H. Brouwer, A. R. Lewis, J.-M. Chezeau, J. Am. Chem. Soc., 2001, 123, pp. 6882
A. Jomekian, S. Mansoon, B. Bazooyar, A. Moradian, J. Porous Mater., 2012, 19, pp. 979
R. W. Wang, W. T. Liu, S. Ding, Z. T. Zhang, J. X. Li, S. L. Qiu, Chem. Commun., 2010, 46, 7418.

1: A process for preparing a zeolitic material having a zeolitic framework structure which exhibits a molar ratio (a Al₂O₃):SiO₂ or a crystalline precursor thereof, wherein a is a number in the range of from 0 to 0.5, said process comprising:
(i) preparing a mixture comprising H₂O, one or more compounds comprising Si from which SiO₂ in the zeolitic framework structure is formed, said one or more compounds comprising a silica gel exhibiting a molar ratio (c H₂O):SiO₂ wherein c is a number in the range of from 0 to 2.5, and optionally one or more compounds comprising Al from which Al₂O₃ in the zeolitic framework structure is formed, wherein said mixture comprises the one or more compounds comprising Si and optionally the one or more compounds comprising Al in amounts so that for Si expressed as SiO₂ and for Al expressed as Al₂O₃, the mixture exhibits a molar ratio (b H₂O):(a Al₂O₃+SiO₂) wherein b is a number in the range of from 0 to 2.0; and
(ii) subjecting the mixture obtained in (i) to crystallization at a crystallization temperature in the range of from 110 to 350° C., and for a crystallization time in the range of from 0.1 to 48 h, obtaining the zeolitic material having a zeolitic framework structure which exhibits a molar ratio (a Al₂O₃):SiO₂ or the crystalline precursor thereof.

2: The process of claim 1, wherein the zeolitic framework structure of the zeolitic material exhibits framework type BEA, CHA, MFI, MEL, MOR, CDO, AEI, FER, SAV, or a mixed type of two or more thereof.

3: The process of claim 1, wherein c is in the range of from 0.01 to 2.4.

4: The process of claim 1, wherein b is in the range of from 0.01 to 2.

5: The process of claim 1, wherein the mixture prepared in (i) comprises two or more compounds comprising Si from which SiO₂ in the zeolitic framework structure is formed, wherein the two or more compounds comprising Si from which SiO₂ in the zeolitic framework structure is formed comprise at least one selected from the group consisting of a sodium silicate, a white carbon black, an amorphous silica powder, and a fumed silica.

6: The process of claim 1, wherein the one or more compounds comprising Al from which Al₂O₃ in the zeolitic framework structure is formed comprise one or more of an aluminum sulfate, a sodium aluminate, and a boehmite.

7: The process of claim 1, wherein the mixture prepared in (i) further comprises a compound comprising an alkali metal M in an amount so that for M expressed as M₂O, the mixture exhibits a molar ratio (d M₂O):(a Al₂O₃+SiO₂) wherein d is a number in the range of from 0 to 0.6.

8: The process of claim 1, wherein the mixture prepared in (i) further comprises seed crystals SC comprising zeolitic material having a zeolitic framework structure exhibiting the framework type of the zeolitic material to be prepared, wherein the mixture prepared in (i) comprises the seed crystals SC in an amount so that mixture exhibits a weight ratio of the seed crystals SC relative to the mixture prepared in (i) in the range of from 0 to 5%.

9: The process of claim 1, wherein the mixture prepared in (i) further comprises an organotemplate compound OC for the zeolitic material to be prepared, wherein the mixture prepared in (i) comprises the organotemplate compound OC in an amount so that mixture exhibits a molar ratio (f OC):(a Al₂O₃+SiO₂) wherein f is a number in the range of from 0 to 1.5.

10: The process of claim 1,
wherein the mixture prepared in (i) optionally further comprises a compound comprising an alkali metal M in an amount so that for M expressed as M₂O, the mixture exhibits a molar ratio (d M₂O):(a Al₂O₃+SiO₂) wherein d is a number in the range of from 0 to 0.6,
wherein the mixture prepared in (i) optionally further comprises seed crystals SC comprising a zeolitic material having a zeolitic framework structure exhibiting the framework type of the zeolitic material to be prepared, wherein the mixture prepared in (i) comprises the seed crystals SC in an amount so that mixture exhibits a weight ratio of the seed crystals SC relative to the mixture prepared in (i) in the range of from 0 to 5%,
wherein the mixture prepared in (i) optionally further comprises an organotemplate compound OC for the zeolitic material to be prepared, wherein the mixture prepared in (i) comprises the organotemplate compound OC in an amount so that mixture exhibits a molar ratio (f OC):(a Al₂O₃+SiO₉) wherein f is a number in the range of from 0 to 1.5,
wherein at least 99 weight-% of the mixture prepared in (i) consist of H₂O, the one or more compounds comprising Si from which SiO₂ in the zeolitic framework structure is formed, optionally the one or more compounds comprising Al from which Al₂O₃ in the zeolitic framework structure is formed, optionally the compound comprising an alkali metal M, optionally the seed crystals SC and optionally the organotemplate compound OC.

11: The process of claim 1, wherein preparing the mixture in (i) comprises grinding, wherein the grinding is carried out at a temperature of the mixture in the range of from 10 to 50° C.

12: The process of claim 1, wherein subjecting the mixture obtained in (i) to crystallization according to (ii) is carried out in a pressure-tight vessel.

13: The process of claim 1, wherein the crystallization temperature according to (ii) is in the range of from 200 to 350° C., and wherein the crystallization time according to (ii) is in the range of from 0.2 to 36 h.

14: The process of claim 1, wherein the zeolitic material obtained in (ii) or the crystalline precursor obtained in (ii) is calcined.

15: A zeolitic material having a zeolitic framework structure which exhibits a molar ratio (a Al₂O₃):SiO₂ or a crystalline precursor thereof, obtained by a process according to claim 1, wherein a is a number in the range of from 0 to 0.5.
